(19) United States
(12) Patent Application Publication
(10) Pub. No.: US 2018/0205797 A1
(43) Pub. Date: Jul. 19, 2018

(54) GENERATING AN ACTIVITY SEQUENCE FOR A TELECONFERENCE SESSION

(71) Applicant: MICROSOFT TECHNOLOGY LICENSING, LLC, Redmond, WA (US)

(72) Inventor: Jason Thomas Faulkner, Seattle, WA (US)

(21) Appl. No.: 15/406,751

(22) Filed: Jan. 15, 2017

(51) Int. Cl. H04L 29/08; H04L 29/06

(52) U.S. Cl. CPC H04L 67/14; H04L 65/1083; H04L 67/10

(57) ABSTRACT

Described herein is a system configured to generate an activity sequence of a teleconference session to be output (e.g., displayed) on a client computing device. The system is configured to record a teleconference session. After the teleconference session is completed or while the teleconference session is still being conducted (e.g., an on-going teleconference session), the system receives input that indicates a user has requested to view the activity sequence of missed content of the teleconference session. The system is configured to determine notable events associated with the missed content of the teleconference session and to generate the activity sequence so that the activity sequence can be displayed to the user via the client computing device. The activity sequence includes recorded portions of the teleconference session that contain activity and content associated with the notable events.

### BACKGROUND

At present, the use of teleconference (e.g., videoconference) systems in personal and commercial settings has increased dramatically so that meetings between people in remote locations can be facilitated. In general, teleconference systems allow users, in two or more remote locations, to communicate interactively with each other via live, simultaneous two-way video streams, audio streams, or both. Some teleconference systems (e.g., CISCO WEBEX provided by CISCO SYSTEMS, Inc. of San Jose, Calif., GOTO MEETING provided by CITRIX SYSTEMS, INC. of Santa Clara, Calif., ZOOM provided by ZOOM VIDEO COMMUNICATIONS of San Jose, Calif., GOOGLE HANGOUTS by ALPHABET INC. of Mountain View, Calif., and SKYPE provided by the MICROSOFT CORPORATION, of Redmond, Wash.) also allow users to exchange files and/or share display screens that present, for example, images, text, video, applications, online locations, social media, and any others.

Teleconference systems enable a user to join a teleconference session (e.g., a meeting) via a remote device. In some scenarios, the user may join the teleconference session late or at a time after the teleconference session starts due to a scheduling conflict, for example (e.g., a late lunch, another scheduled meeting at the same time, etc.). In such scenarios, the user is typically unaware of the activity that had previously occurred in the teleconference session before the user joins.

In additional scenarios, the user may have missed a teleconference session that has ended, again due to a scheduling conflict, for example. In these additional scenarios, if the user wants to know what occurred in the teleconference session that has ended, the user typically needs to access a recording of the completed teleconference session and try to navigate (e.g., fast forward and/or rewind) the recording to try to find and to view the relevant activity that occurred in the teleconference session.

### SUMMARY

The disclosed system addresses the problems described above with regards to a teleconference session. Specifically, the disclosed system is configured to generate an activity sequence that summarizes a teleconference session. The activity sequence includes notable events that occur in the teleconference session. A notable event includes activity (e.g., one or more actions) considered to be important or relevant to a context of the teleconference session, such that knowledge of the activity enables a user to gain an awareness of what has occurred in the teleconference session (e.g., who joined, who left, what topics were discussed, what files were shared, etc.). Stated another way, notable events include missed actions that provide value to, or contribute to, a general summary of the teleconference session such that the user can quickly understand the context of the teleconference session by consuming (e.g., viewing and/or listening to) a shortened version of behavior-related content rather than having to consume all the recorded content in the teleconference session.

In an example where a teleconference session has already ended at a time a request to consume the activity sequence is received (e.g., the user missed the whole teleconference session), the activity sequence provides notable events that occur in the completed teleconference session. Upon viewing and/or listening to the activity sequence and gaining a general awareness and understanding of the missed content of the completed teleconference session, the user can make an informed decision on whether to access a full recording of the completed teleconference session so the content of the completed teleconference session can be viewed and/or listened to in greater detail than that provided in the activity sequence. In another example where a teleconference session is on-going at a time a request to consume the activity sequence is received (e.g., a user is thinking about joining an on-going teleconference session late or at a time after a start time), the activity sequence provides notable events of a portion of the teleconference session such as those that occur up to a point in time associated with the request to view and/or listen to the activity sequence is received. Upon viewing and/or listening to the activity sequence and gaining a general awareness and understanding of the missed content of the portion of the teleconference session, the user can make an informed decision on whether to join the teleconference session late and to participate in further discussion of the on-going teleconference session.

Accordingly, the system described herein organizes, or curates, different recorded portions of a teleconference session into an activity sequence, wherein an individual recorded portion of the teleconference session in the activity sequence captures activity and content (e.g., audio and/or visual content) associated with an event determined to be notable. Again, a notable event can comprise one or more important or relevant actions that contribute to or provide value to a general awareness and understanding of a context of a teleconference session. Consequently, playback and user consumption of the activity sequence provides the user with an efficient means to gain a general awareness and understanding of what has occurred in the teleconference session without requiring the user to view and/or listen to all the recorded content of the teleconference session that the user missed. In other words, the activity sequence enables the user to preview an audio/visual “montage” or a summary “video” of the teleconference session in which the audio/visual montage includes user behavior-driven stacking of notable events.

As described in the examples herein, different types of notable events can be detected by the system. In some instances, the types of notable events the system monitors for and detects can be defined by a user (e.g., a host user of a teleconference session). A notable event can be associated with one or more of: an action in which a user joins the teleconference session, an action in which a user leaves the teleconference session, an action in which a file and/or a display screen (e.g., a presentation, a document, a video, a web page, a user interface of an application, etc.) is shared in the teleconference session, an action in which a session topic is introduced in the teleconference session (e.g., a switch from one topic of discussion to another), an action in which a different participant begins speaking in the teleconference session (e.g., a switch from one speaking participant to another), an action in which file content being displayed in the teleconference session changes (e.g., a switch that turns from one slide of a presentation file to a next slide, a switch that turns from one page of a document file to a next page, etc.), an action in the teleconference session where a user explicitly flags (e.g., tags, marks, etc.) content as being notable, an action in the teleconference session in which a user performs a particular motion (e.g., raises a hand, stands up from a sitting position, etc.) or has an increased amount of motion compared to a threshold or normal amount (e.g., head, arm, or hand gestures), at least one responsive action (e.g., a smile, a laugh, a smirk, a raised eye brow, etc.) by at least one participant in the teleconference session that was likely evoked by at least one previous action (e.g., a joke, a funny movement, a controversial statement, etc.) by at least one other participant, or any other activity determined to provide value or contribute to a general summary of the teleconference session.

In additional examples described herein, another type of notable event can comprise a portion of the teleconference session that includes concentrated activity. The concentrated activity can indicate that an amount of total group activity within a period of time exceeds a threshold amount (e.g., a baseline amount and/or a normal amount). For instance, concentrated activity can occur when a threshold number of different participants (e.g., three, four, five, etc.) speak in a shortened period of time, thereby increasing a likelihood that the content being discussed is important or relevant. Or, concentrated activity can occur when displayed file content (e.g., a page of a document file, a slide of a presentation file, a spreadsheet of a spreadsheet file, etc.) being shared is edited by one or more users rather than only being presented.

A recorded portion of the teleconference session included in an activity sequence can comprise one or more of a video segment (e.g., a video clip), an audio segment (e.g., an audio clip), still media (e.g., a user avatar, an image, a portion of a file such as a page of a document or a slide in a presentation, etc.), chat content (e.g., a message thread), or other content that is visually (e.g., graphically) and/or audibly output in the teleconference session. The duration of an individual recorded portion of the teleconference session is sufficient to capture and illustrate the notable event (e.g., notable activity) contained therein. However, since the activity sequence is generated and presented to save time for a user, a duration of an individual recorded portion of the teleconference session can be short in many instances and may have a maximum duration. For example, a duration of an individual recorded portion may be between one second and thirty seconds where thirty seconds is the maximum duration. In various examples, the duration of a recorded portion of the teleconference session can depend on a type of notable event contained therein (e.g., a user joining, a user leaving, a document being shared, concentrated activity, etc.). For instance, a period of time in the teleconference session where a user joins may be captured in a video clip with a duration of two or three seconds, while a video clip of teleconference session in which concentrated activity occurs (e.g., a question is asked and multiple different people speak to provide an answer) may need a longer duration (e.g., fifteen seconds, thirty seconds, etc.) to better provide a viewer with an awareness and understanding of the notable event. In alternative examples, each of the recorded portions of the teleconference session can have the same duration. Furthermore, the duration of an individual recorded portion of the teleconference session can depend upon a determined length of the activity sequence (e.g., as selected by a user).

As described herein, a system is configured to record a teleconference session. After the teleconference session is completed or while the teleconference session is still being conducted (e.g., an on-going teleconference session), the system receives input that indicates a user has requested to view an activity sequence that summarizes missed content of the teleconference session. The system is configured to determine notable events associated with the missed content of the teleconference session. The system generates the activity sequence which includes recorded portions of the teleconference session that contain the activity and content associated with the notable events and causes the activity sequence to be displayed on a client computing device of the user. Consequently, via consumption of the activity sequence, the user is provided with an audio/visual montage so that the user can gain a general awareness and understanding of significant activity that was missed without having to view and/or listen to all the missed content of a teleconference session. In some examples, the recorded portions of the teleconference session in the activity sequence are presented in order based on a time in the teleconference session at which they occur. In other examples, the recorded portions of the teleconference session in the activity sequence can be presented out of order. For example, notable events can be grouped according to one or more person(s) that perform the notable events, and the activity sequence can be presented according to person(s) such that the activity sequence first shows notable events of first person(s), then shows notable events of second person(s), and so forth.

In various examples, there is no limit on a length of the activity sequence and the activity sequence contains all the notable events determined by the system. However, in other examples, the activity sequence may be limited by a length (e.g., one minute, two minutes, three minutes, five minutes, etc.). The length limit on the activity sequence may be defined by the system. Moreover, the length limit on the activity sequence may depend on an overall length of the teleconference session to be summarized (e.g., the missed content). The system can be configured to assign a priority to the notable events so that they are ranked (e.g., via priority values), and further to select a subset of the notable events to include in the activity sequence. Using the rankings based on priority, the system can select the subset of the plurality of notable actions to include in the activity sequence.

Multiple different factors can be used by the system to determine the priority. In one example, a priority factor considered by the system can include a type of event. For instance, concentrated activity in the teleconference session may be weighted to have a higher priority than a new or different user speaking in the teleconference session. In another example, a priority factor considered by the system can include a location on a user interface at which activity and content associated with an event occurs. For instance, a system can determine if the activity and the content is displayed in a primary display area (e.g., active stage) of the user interface or a secondary display area (e.g., passive stage) of the user interface, because a user joining the primary display area may be weighted to have a higher priority than a user joining the secondary display area. In yet another example, a priority factor considered by the system can include a period of time in which file content is displayed (e.g., in the primary display area). For instance, if one slide of a presentation file is displayed and talked about in the teleconference session longer than other slides of the presentation file, then a slide turn that switches a display to the one slide may be weighted to have a higher priority than other slide turns that switch a display to the other slides. Or, if a first deck of presentation slides is displayed and talked about in the teleconference session longer than a second deck of presentation slides, then individual slide turns in the first deck of presentation slides may be weighted to have a higher priority than individual slide turns in the second deck of presentation slides so that the activity sequence includes more file content from the first deck than from the second deck. In a further example, a priority factor considered by the system can include temporal proximity of activity. For instance, an increased amount of group activity that occurs within a shortened period of time (e.g., the concentrated activity described above) may be weighted to have a heightened priority because of the relevance of group collaboration and interaction to the context of a teleconference session. In even a further example, a priority factor considered by the system can include a number of types of events that are associated with the same activity. For instance, if the display switches from a first person to a second person and the speaker of the session switches from the first person to the second person at the same time, then an increased number (e.g., two in this example) of types of notable events may further increase the priority of the activity. Moreover, a priority factor considered by the system can include a person that performs or is a source of a notable event. For instance, notable events performed by a host user of the teleconference session may have a higher priority than a notable event performed by a passive user of the teleconference session. Accordingly, the teleconference session can include profile data that has an indicator regarding the importance of a participant.

In additional examples, a priority factor can include an intent to achieve a balance in types of notable events to include in the activity sequence so that the activity sequence is more encompassing and can better capture the context of missed content. An acceptable balance can be achieved by establishing a cap (e.g., a maximum number) on individual types of events included in the activity sequence. For instance, if the teleconference session is large and includes forty participants, the user likely does not want to see forty different participants join the teleconference session in a one minute activity sequence because the whole activity sequence would merely be people joining the teleconference session. Rather, the user may only want to see the most important people join (e.g., the host of the teleconference session, the main speaker(s), a supervisor of a group, etc.) so that the rest of the activity sequence can include recorded portions of the teleconference session that contain types of notable events other than users joining. Accordingly, a number of a specific type of notable event that are included in the activity sequence may be capped at a maximum number (e.g., two, three, four, five, etc.). Some types of events deemed to be more relevant, may not have a cap. In instances where a maximum number is applied to a type of notable event the maximum number can vary based on a type of event, a determined length of the activity sequence, and/or a number of recorded portions of content included in the activity sequence.

In some implementations, a host user of the teleconference session (e.g., a person that created and/or shared an object to invite others to a meeting) can specify which priority factors can be used to determine and assign priority to detected events. The host user may specify the priority factors prior to a start of the teleconference session or during the teleconference session. Consequently, the system can be configured to implement, using the assigned priorities, some sort of cutoff or threshold with respect to which notable events to include in the activity sequence so that the activity sequence fits within a specified length of time (e.g., one minute, two minutes, three minutes, etc.). As described above, the cutoff or threshold can be a sliding cutoff or threshold that moves up and down a ranked priority of events (e.g., a priority stacking) based on a specified length of the activity sequence and/or individual durations of a number of recorded portions of the teleconference session to be included in the activity sequence to fully capture the activity and the content associated with notable events.

In some examples, the system can provide an ability for a user to select a length of the activity sequence. The length can be selected from multiple available lengths. In this way, a user can have an element of control over a level of detail in the activity sequence (e.g., based on how much available time the user has to consume the activity sequence). For instance, a activity sequence with a length of one minute will likely comprise less recorded portions than a activity sequence with a length of five minutes. Consequently, the selection of the notable events to include in the activity sequence can further be based on the length of the activity sequence selected by the user. In some implementations, the selected length of the activity sequence can also affect a duration (e.g., a maximum duration) of an individual recorded portion of the teleconference session that contains a particular type of notable action. For instance, if a ten-minute activity sequence is selected by the user then a duration of concentrated activity may be thirty seconds. In contrast, if a one-minute activity sequence is selected by the user then a duration of the concentrated activity may be ten seconds. In some implementations, the lengths of the activity sequence available for selection may depend on an overall length of the teleconference session to be summarized (e.g., the system can provide an option to view a longer activity sequence for a two-hour teleconference session compared to a shorter activity sequence for a thirty-minute teleconference session).

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a diagram illustrating an example environment in which a system can generate an activity sequence to be output (e.g., displayed) on a client computing device.

FIG. 2 is a diagram illustrating example components of an example device configured to generate an activity sequence to be output (e.g., displayed) on a client computing device.

FIG. 3 illustrates an example graphical user interface configured to enable a user to request to view an activity sequence in association with an object of an application that is separate from, or external to, a teleconference application and/or configured to output (e.g., display) the activity sequence.

FIG. 4 illustrates another example graphical user interface configured to enable a user to request to view an activity sequence in association with an object of an application that is separate from, or external to, a teleconference application and/or configured to output (e.g., display) the activity sequence.

FIG. 5 illustrates an example graphical user interface configured to enable a user to request to view an activity sequence after joining a teleconference session experience provided by a teleconference application and/or configured to output (e.g., display) the activity sequence.

FIG. 6 illustrates another example graphical user interface configured to enable a user to request to view an activity sequence after joining a teleconference session experience provided by a teleconference application and/or configured to output (e.g., display) the activity sequence.

FIG. 7 is a diagram of an example flowchart that illustrates operations directed to generating and outputting an activity sequence.

FIG. 8 is a diagram of an example flowchart that illustrates operations directed to selecting a subset of notable events to include in an activity sequence based on priority.

FIG. 9 illustrates an example graphical user interface that includes options for a user to select a length of an activity sequence from multiple different available lengths.

FIGS. 10A and 10B illustrate example graphical user interfaces that include content and activity associated with a joining event, which can be captured in a recorded portion of the teleconference session.

FIGS. 11A and 11B illustrate example graphical user interfaces that include content and activity associated with a leaving event, which can be captured in a recorded portion of the teleconference session.

FIGS. 12A and 12B illustrate example graphical user interfaces that include content and activity associated with a file and/or display screen sharing event, which can be captured in a recorded portion of the teleconference session.

FIG. 13 illustrates an example graphical user interface that includes content and activity associated with a topic introduction event, which can be captured in a recorded portion of the teleconference session.

FIGS. 14A and 14B illustrate example graphical user interfaces that include content and activity associated with a change in speaker event, which can be captured in a recorded portion of the teleconference session.

FIGS. 15A and 15B illustrate example graphical user interfaces that include content and activity associated with a change in displayed file content event, which can be captured in a recorded portion of the teleconference session.

FIG. 16 illustrates an example graphical user interface that includes content and activity associated with an explicitly flagged event, which can be captured in a recorded portion of the teleconference session.

FIG. 17 illustrates an example graphical user interface that includes content and activity associated with a concentrated activity event, which can be captured in a recorded portion of the teleconference session.

FIG. 18 illustrates an example graphical user interface that includes content and activity associated with a motion event, which can be captured in a recorded portion of the teleconference session.

FIGS. 19A and 19B illustrate example graphical user interfaces that include content and activity associated with an evoked response event, which can be captured in a recorded portion of the teleconference session.

### DETAILED DESCRIPTION

Examples described herein enable a system to generate an activity sequence of a teleconference session to be output (e.g., displayed) on a client computing device. The system is configured to record a teleconference session. After the teleconference session is completed or while the teleconference session is still being conducted (e.g., an on-going teleconference session), the system receives input that indicates a user has requested to view an activity sequence of missed content of the teleconference session. The system is configured to determine notable events associated with the missed content of the teleconference session and to generate the activity sequence so that it can be displayed to the user via the client computing device. The activity sequence includes recorded portions of the teleconference session that contain activity and content associated with the notable events.

As described above, the system generates the activity sequence so that a viewer can gain a general awareness and understanding of missed content of the teleconference session without having to view all the recorded content that was missed. Via the generation of the activity sequence, the user does not have to attempt to navigate all the recorded content to try and find where the notable events occur. Rather, the system described herein packages (e.g., stacks) the notable events into the activity sequence (e.g., a summary video) so the user is provided with an efficient tool to gain a general awareness and understanding of missed content of the teleconference session. Consequently, user time and/or computing resources are conserved via this efficient way to provide a user with a general awareness and understanding of a teleconference session.

In at least one implementation, the activity sequence serves as a tool to bring a user up to speed in an on-going teleconference session that the user is thinking about joining late. Thus, the user can request to view the activity sequence prior to joining the on-going teleconference session. In various examples described herein, the activity sequence can be displayed to the user within a teleconference session experience of a teleconference application (e.g., the teleconference session portal). In other examples described herein, the activity sequence can be displayed in association with an object of an application that is external to, or separate from, the teleconference application. For instance, the object can be associated with: a comment in a chat application, an appointment of a calendar application, an electronic message of an email application, a notification (e.g., an end-of-meeting notification) in a chat application or a social media application. In some examples, the object can be configured with a link to the teleconference session.

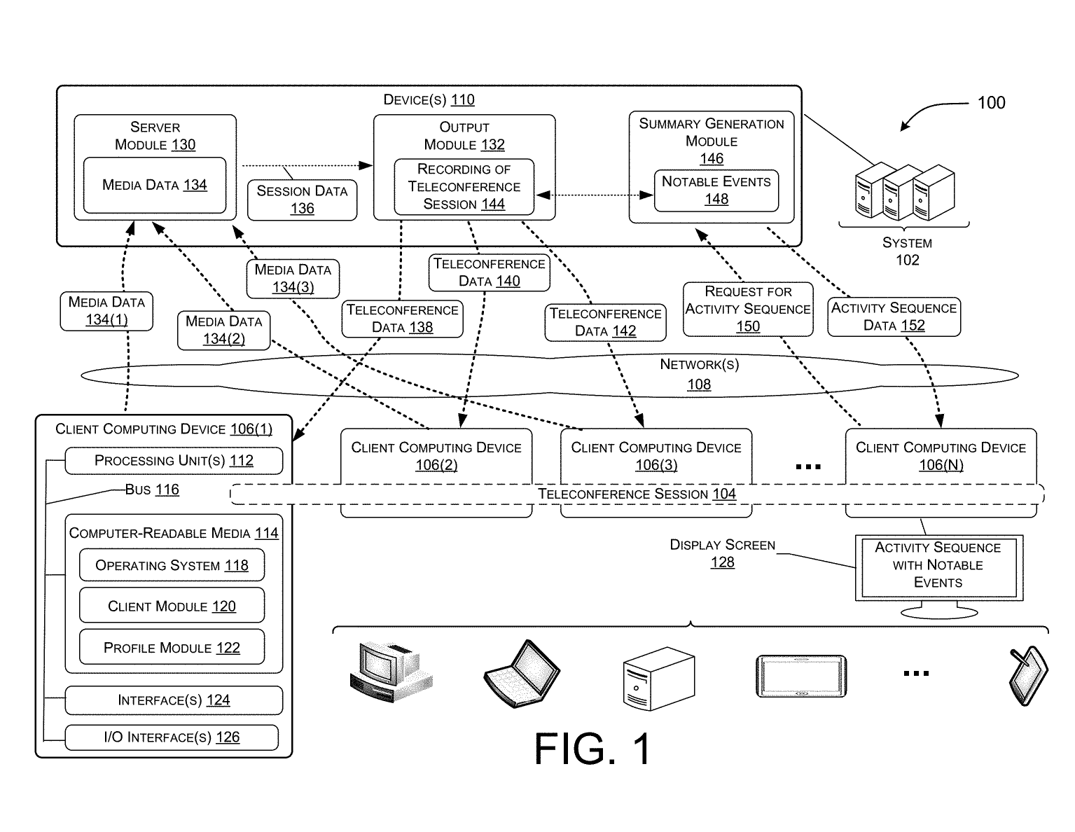

Various examples, implementations, scenarios, and aspects are described below with reference to FIGS. 1 through 19B.

FIG. 1 is a diagram illustrating an example environment 100 in which a system 102 can operate to generate an activity sequence for a teleconference session 104. In this example, the teleconference session 104 is implemented between a number of client computing devices 106(1) through 106(N) (where N is a positive integer number having a value of two or greater). The client computing devices 106(1) through 106(N) enable users to participate in the teleconference session 104. In this example, the teleconference session 104 is hosted, over one or more network(s) 108, by the system 102. That is, the system 102 can provide a service that enables users of the client computing devices 106(1) through 106(N) to participate in the teleconference session 104. Consequently, a “participant” to the teleconference session 104 can comprise a user and/or a client computing device (e.g., multiple users may be in a conference room participating in a teleconference session via the use of a single client computing device), each of which can communicate with other participants. As an alternative, the teleconference session 104 can be hosted by one of the client computing devices 106(1) through 106(N) utilizing peer-to-peer technologies.

In examples described herein, client computing devices 106(1) through 106(N) participating in a teleconference session 104 are configured to receive and render for display, on a user interface of a display screen, teleconference data. The teleconference data can comprise a collection of various instances, or streams, of content. For example, an individual stream of content can comprise media data associated with a live video feed (e.g., audio and visual data that capture the appearance and speech of a user participating in the teleconference session). Another example of an individual stream of content can comprise media data that includes an avatar of a user participating in the teleconference session along with audio data that captures the speech of the user. Yet another example of an individual stream of content can comprise media data that includes a file displayed on a display screen along with audio data that captures the speech of a user. Accordingly, the various streams of content within the teleconference data enable a remote meeting to be facilitated between a group of people and the sharing of content within the group of people.

The system 102 includes device(s) 110. The device(s) 110 and/or other components of the system 102 can include distributed computing resources that communicate with one another and/or with the client computing devices 106(1) through 106(N) via the one or more network(s) 108. In some examples, the system 102 may be an independent system that is tasked with managing aspects of one or more teleconference sessions such as teleconference session 104. As an example, the system 102 may be managed by entities such as SLACK, WEBEX, GOTOMEETING, GOOGLE HANGOUTS, etc.

Network(s) 108 may include, for example, public networks such as the Internet, private networks such as an institutional and/or personal intranet, or some combination of private and public networks. Network(s) 108 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 108 may utilize communications protocols, including packet-based and/or datagram-based protocols such as Internet protocol (“IP”), transmission control protocol (“TCP”), user datagram protocol (“UDP”), or other types of protocols. Moreover, network(s) 108 may also include a number of devices that facilitate network communications and/or form a hardware basis for the networks, such as switches, routers, gateways, access points, firewalls, base stations, repeaters, backbone devices, and the like.

In some examples, network(s) 108 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, and so forth), and other standards.

In various examples, device(s) 110 may include one or more computing devices that operate in a cluster or other grouped configuration to share resources, balance load, increase performance, provide fail-over support or redundancy, or for other purposes. For instance, device(s) 110 may belong to a variety of classes of devices such as traditional server-type devices, desktop computer-type devices, and/or mobile-type devices. Thus, although illustrated as a single type of device—a server-type device—device(s) 110 may include a diverse variety of device types and are not limited to a particular type of device. Device(s) 110 may represent, but are not limited to, server computers, desktop computers, web-server computers, personal computers, mobile computers, laptop computers, tablet computers, or any other sort of computing device.

A client computing device (e.g., one of client computing device(s) 106(1) through 106(N)) may belong to a variety of classes of devices, which may be the same as, or different from, device(s) 110, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (AR) device, an implanted computing device, an automotive computer, a network-enabled television, a thin client, a terminal, an Internet of Things (“IoT”) device, a work station, a media player, a personal video recorders (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 106(1) through 106(N) of the various classes and device types can represent any type of computing device having one or more processing unit(s) 112 operably connected to computer-readable media 114 such as via a bus 116, which in some instances can include one or more of a system bus, a data bus, an address bus, a PCI bus, a Mini-PCI bus, and any variety of local, peripheral, and/or independent buses.

Executable instructions stored on computer-readable media 114 may include, for example, an operating system 118, a client module 120, a profile module 122, and other modules, programs, or applications that are loadable and executable by processing units(s) 112.

Client computing device(s) 106(1) through 106(N) may also include one or more interface(s) 124 to enable communications between client computing device(s) 106(1) through 106(N) and other networked devices, such as device(s) 110, over network(s) 108. Such network interface(s) 124 may include one or more network interface controllers (NICs) or other types of transceiver devices to send and receive communications and/or data over a network. Moreover, a client computing device 106(1) can include input/output (“I/O”) interfaces 126 that enable communications with input/output devices such as user input devices including peripheral input devices (e.g., a game controller, a keyboard, a mouse, a pen, a voice input device such as a microphone, a touch input device, a gestural input device, and the like) and/or output devices including peripheral output devices (e.g., a display, a printer, audio speakers, a haptic output device, and the like). FIG. 1 illustrates that client computing device 106(N) is in some way connected to a display device 128 (e.g., a display screen), which can present the activity sequence for the teleconference session 104, as shown.

In the example environment 100 of FIG. 1, client computing devices 106(1) through 106(N) may use their respective client modules 120 to connect with one another and/or other external device(s) in order to participate in the teleconference session 104. For instance, a first user may utilize a client computing device 106(1) to communicate with a second user of another client computing device 106(2). When executing client modules 120, the users may share data, which may cause the client computing device 106(1) to connect to the system 102 and/or the other client computing devices 106(2) through 106(N) over the network(s) 108.

The client computing device(s) 106(1) through 106(N) may use their respective profile module 122 to generate participant profiles, and provide the participant profiles to other client computing devices and/or to the device(s) 110 of the system 102. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for teleconference sessions.

As shown in FIG. 1, the device(s) 110 of the system 102 includes a server module 130 and an output module 132. The server module 130 is configured to receive, from individual client computing devices such as client computing devices 106(1) through 106(3), media data 134(1) through 134(3). Media data can comprise a live video feed (e.g., audio and visual data associated with a user), audio data which is to be output with a presentation of an avatar of a user (e.g., an audio only experience in which live video data of the user is not transmitted), text data (e.g., text messages), file data and/or screen sharing data (e.g., a document, a slide deck, an image, a video displayed on a display screen, etc.), and so forth. Thus, the server module 130 is configured to receive a collection of various instances of media data 134(1) through 134(3) (the collection being referred to herein as media data 134). In some scenarios, not all the client computing devices utilized to participate in the teleconference session 104 provide an instance of media data. For example, a client computing device may only be a consuming, or a “listening”, device such that it only receives content associated with the teleconference session 104 but does not provide any content to the teleconference session 104.

The server module 130 is configured to generate session data 136 based on the media data 134. In various examples, the server module 130 can select aspects of the media data 134 that are to be shared with the participating client computing devices 106(1) through 106(N). Consequently, the server module 130 is configured to pass the session data 136 to the output module 132 and the output module 132 may communicate teleconference data to the client computing devices 106(1) through 106(3). As shown, the output module 132 transmits teleconference data 138 to client computing device 106(1), transmits teleconference data 140 to client computing device 106(2), and transmits teleconference data 142 to client computing device 106(3). The teleconference data transmitted to the client computing devices can be the same or can be different (e.g., positioning of streams of content within a user interface may vary from one device to the next).

The output module 132 is also configured to record the teleconference session (e.g., a version of the teleconference data) and to maintain a recording of the teleconference session 144. The device(s) 110 can also include a summary generation module 146, and in various examples, the summary generation module 146 is configured to access the recording of the teleconference session 144 to determine notable events 148 to include in an activity sequence. The summary generation module 146 can determine the notable events 148 in response to receiving a request for the activity sequence 150 from a client computing device such as client computing device 106(N). The summary generation module 146 can provide the activity sequence (e.g., transmit the activity sequence data 152 or an activity sequence stream) and/or cause the activity sequence to be visually and audibly output on the client computing device 106(N) (e.g., via display screen 128).

In other examples, the summary generation module 146 can be configured to determine notable events 148 as the teleconference session 104 is being conducted (e.g., in real-time and/or without accessing the recording of the teleconference session 144) so that the activity sequence is already generated or is in the process of being generated prior to receiving the request for the activity sequence 150.

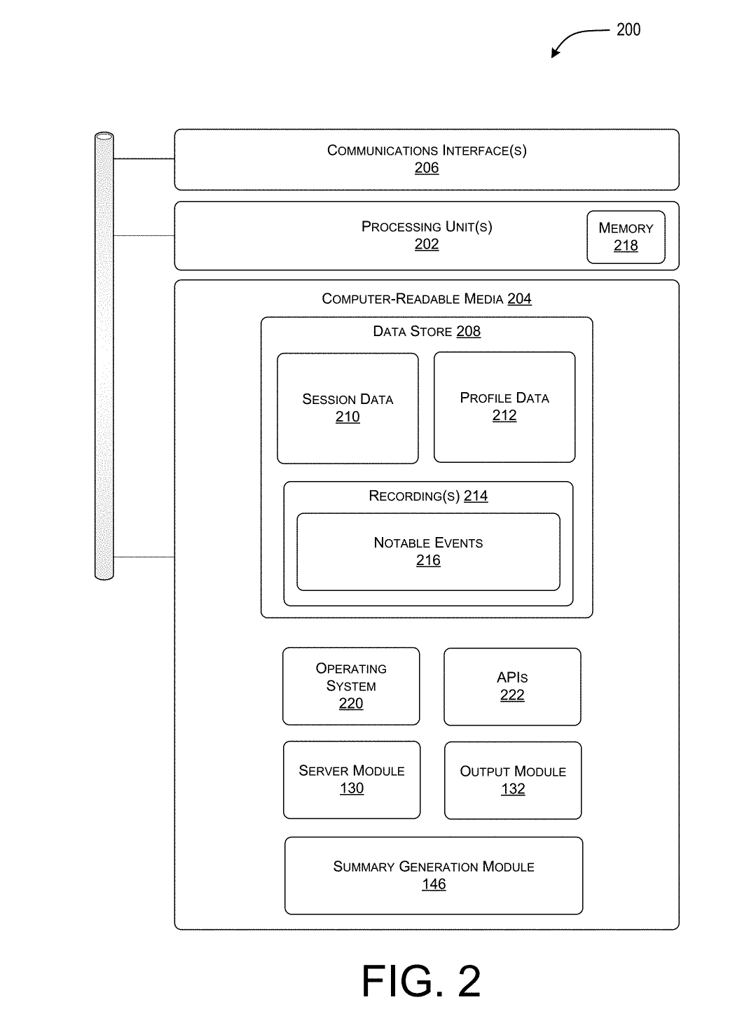

FIG. 2 illustrates a diagram that shows example components of an example device 200 configured to generate an activity sequence for a teleconference session 104 that is to be output via a client computing device 106(N). The device 200 may represent one of device(s) 110, or in other examples a client computing device (e.g., client computing device 106(1)), where the device 200 includes one or more processing unit(s) 202, computer-readable media 204, and communication interface(s) 206. The components of the device 200 are operatively connected, for example, via a bus, which may include one or more of a system bus, a data bus, an address bus, a PCI bus, a Mini-PCI bus, and any variety of local, peripheral, and/or independent buses.

As utilized herein, processing unit(s), such as the processing unit(s) 202 and/or processing unit(s) 112, may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 204 and/or computer-readable media 114, may store instructions executable by the processing unit(s). The computer-readable media may also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 206 may represent, for example, network interface controllers (“NICs”) or other types of transceiver devices to send and receive communications over a network.

In the illustrated example, computer-readable media 204 includes a data store 208. In some examples, data store 208 includes data storage such as a database, data warehouse, or other type of structured or unstructured data storage. In some examples, data store 208 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 208 may store data for the operations of processes, applications, components, and/or modules stored in computer-readable media 204 and/or executed by processing unit(s) 202 and/or accelerator(s). For instance, in some examples, data store 208 may store session data 210 (e.g., session data 136), profile data 212 (e.g., associated with a participant profile), and/or other data. The session data 210 can include a total number of participants (e.g., users and/or client computing devices) in the teleconference session 104, and activity that occurs in the teleconference session 104, and/or other data related to when and how the teleconference session 104 is conducted or hosted. The data store 208 can also include recording(s) 214 of teleconference session(s), and notable events 216 that occur within an individual teleconference session. In various examples, the session data 210 and or a recording 214 of the teleconference session can comprise information related to who joins and when, who leaves and when, who speaks and when, what is currently being displayed in individual display areas of a user interface, files that are shared and when, a transcription of what was spoken, text comments shared and when, and so forth.

Alternately, some or all of the above-referenced data can be stored on separate memories 218 on board one or more processing unit(s) 202 such as a memory on board a CPU-type processor, a GPU-type processor, an FPGA-type accelerator, a DSP-type accelerator, and/or another accelerator. In this example, the computer-readable media 204 also includes operating system 220 and application programming interface(s) 222 configured to expose the functionality and the data of the device 200 to other devices. Additionally, the computer-readable media 204 includes one or more modules such as the server module 130, the output module 132, and the summary generation module 146, although the number of illustrated modules is just an example, and the number may vary higher or lower. That is, functionality described herein in association with the illustrated modules may be performed by a fewer number of modules or a larger number of modules on one device or spread across multiple devices.

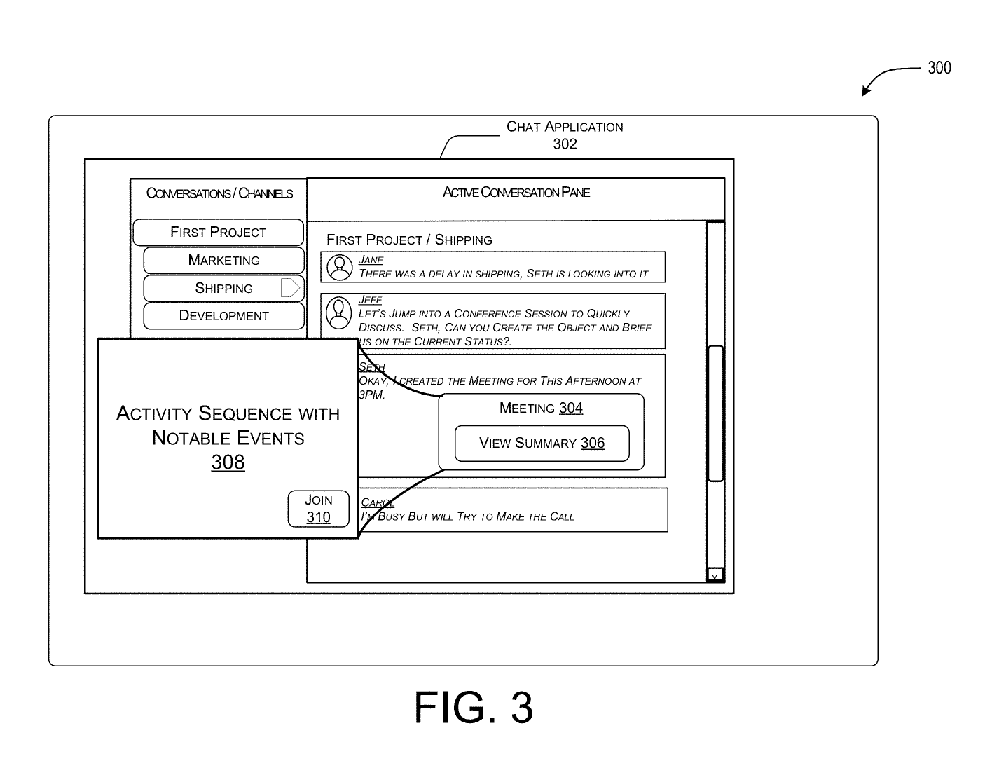

FIG. 3 illustrates an example graphical user interface 300 configured to enable a user to request to view an activity sequence in association with an object of an application that is separate from, or external to, a teleconference application and/or to present the activity sequence. The request can be associated with the request for the activity sequence 150 in FIG. 1.

FIG. 3 illustrates a chat application 302 with which a user may be interacting, the chat application 302 displaying various conversations/channels and/or an active conversation pane with comments. While interacting with the active conversation pane of the chat application 302, the user views a meeting object 304 in a comment posted by another user. The meeting object 304 enables the user to either join a teleconference session or access a full recording of a completed teleconference session (e.g., via an embedded link). The meeting object 304 also includes a selectable option for the user to view a summary 306 of the teleconference session such that, upon selection of the option to view the summary 306, the user is presented with the activity sequence with notable events 308. The activity sequence with the notable events 308 is displayed in association with the meeting object 304 and without redirecting the user to another application (e.g., a teleconference application). Rather, the user can watch a preview of what was missed in the teleconference session without having to leave the chat experience provided by the chat application 302. In the example shown, the activity sequence with the notable events 308 is displayed as a pop-up window, but in other examples, the activity sequence with the notable events 308 can be displayed within the comment (e.g., the comment in which the meeting object 304 lies).

In various examples in which the teleconference session is an on-going teleconference session, the user can view the activity sequence with notable events 308 prior to joining the teleconference session. In this way, the activity sequence with notable events 308 can provide the user with a general awareness and understanding of the context of the teleconference session so that the user can make an informed decision on whether to participate. Moreover, since the user is joining late, the activity sequence with notable events 308 can bring the user up to speed prior to joining the teleconference session. Accordingly, the activity sequence with notable events 308 and/or the meeting object 304 can be associated with an option for the user to join 310 the teleconference session (e.g., after consuming the activity sequence). While the option to join 310 is displayed in association with the activity sequence with notable events 308, the option to join can alternatively be displayed in association with the meeting object 304.

In other examples, the activity sequence with notable events 308 and/or the meeting object 304 can include an option for the user to access a full recording of an already completed teleconference session (e.g., the meeting object 304 may be associated with an end-of-meeting notification).

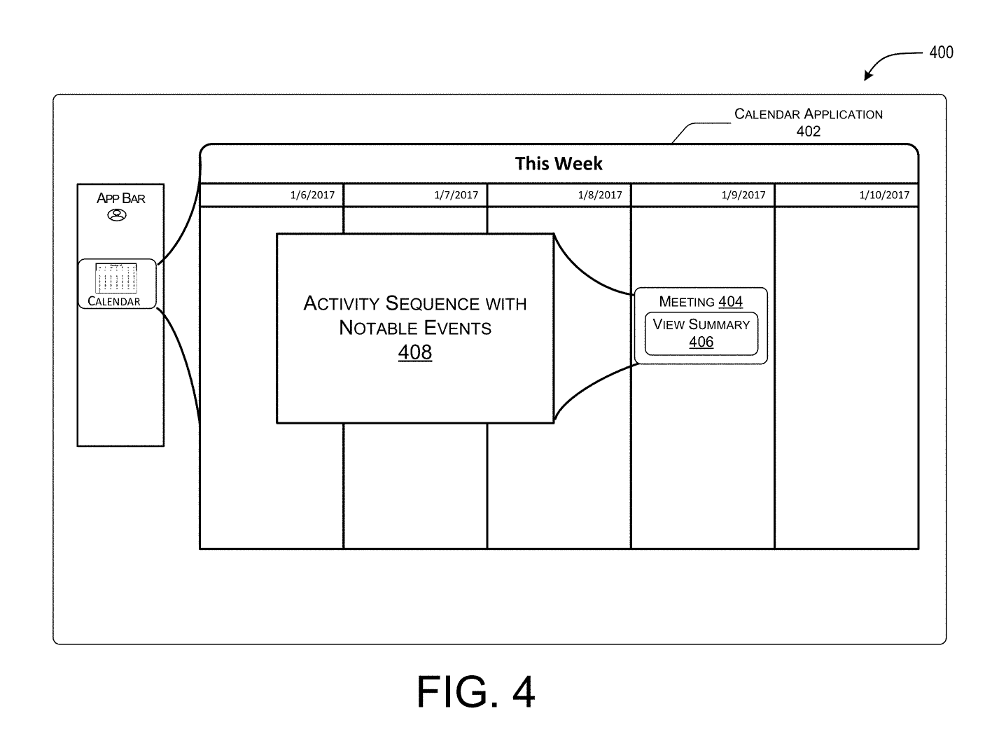

FIG. 4 illustrates another example graphical user interface 400 configured to enable a user to request to view an activity sequence in association with an object of an application that is separate from, or external to, a teleconference application and/or to present the activity sequence. Again, the request can be associated with the request for the activity sequence 150 in FIG. 1.

In FIG. 4, a calendar application 402 is shown, and a user may be interacting with various information (e.g., scheduled appointments) in the calendar application 402. While viewing a particular week in the calendar application 402 (e.g., “This Week”), the user sees a meeting object 404 on a particular day (e.g., the current day or a previous day). Again, the meeting object 404 enables the user to either join an on-going teleconference session or access a full recording of a completed teleconference session (e.g., via an embedded link). The meeting object 404 also includes a selectable option for the user to view a summary 406 of the teleconference session such that, upon selection of the option to view the summary 406, the user is presented with an activity sequence with notable events 408. The activity sequence with the notable events 408 is displayed in association with the meeting object 404 and without redirecting the user to another application (e.g., a teleconference application). Rather, the user can watch a preview of what was missed in the teleconference session without having to leave the calendar viewing experience provided by the calendar application 402.

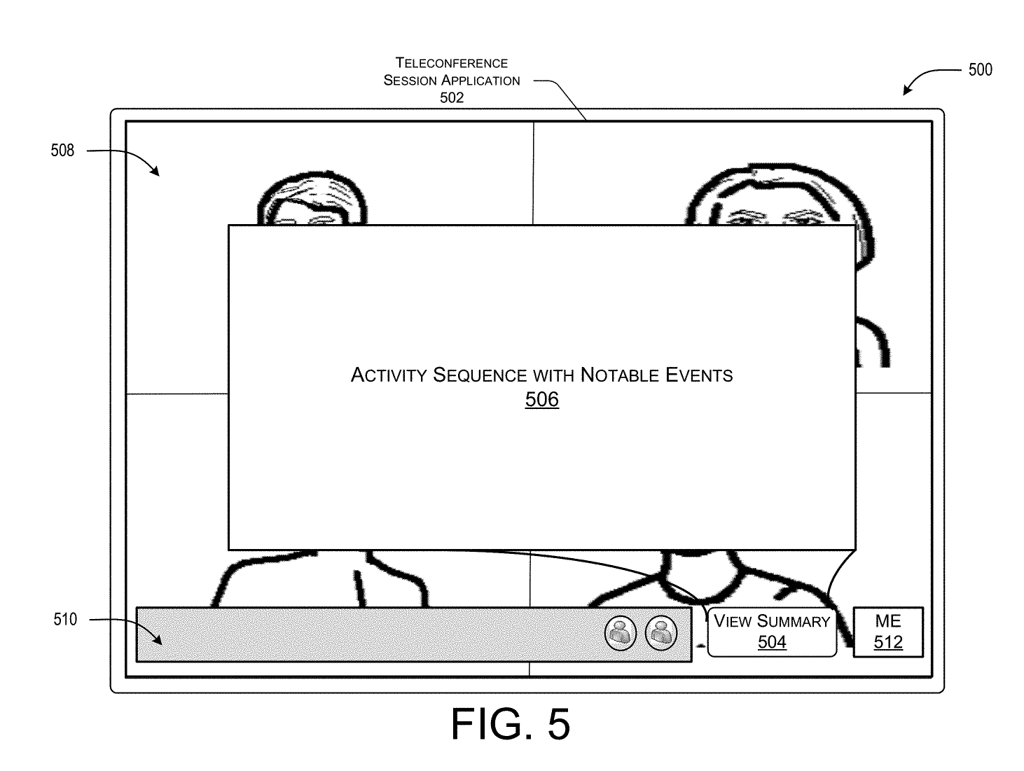

FIG. 5 illustrates an example graphical user interface 500 configured to enable a user to request to view an activity sequence after joining a teleconference session experience provided by a teleconference application 502 and/or to present the activity sequence. The request can be associated with the request for the activity sequence 150 in FIG. 1.

As illustrated in FIG. 5, the request to view the activity sequence is provided via an option to view a summary 504. In response, a activity sequence with notable events 506 is displayed within the teleconference session experience. Here, the user has already joined the teleconference session (e.g., via one of the meeting objects presented in FIG. 3 or FIG. 4), and thus, live content (e.g., the grid displaying four streams of live content from four participants) of the teleconference session that is on-going is in the background and is currently and temporarily paused so that the user can focus his or her attention on the activity sequence with notable events 506. Upon completion of the activity sequence with notable events 506, the live content can resume and the user is fully participating in the teleconference session.

In various examples, a user interface of the teleconference session can comprise different display areas such as a primary display area 508 and a secondary display area 510. In this example, the primary display area 508 comprises all or a large portion of the user interface and displays the grid of live content (e.g., the streams of live content from four participants). The participants in the primary display area 508 may be referred to as active participants. The secondary display area 510 is typically smaller compared to the primary display area 508 and can be displayed on the bottom of the user interface. The secondary display area 510 may include avatars that represent other participants to the teleconference session, which may be referred to as passive participants. Consequently, the primary display area 508 is typically displayed in a manner that dominates the graphical user interface on a display screen compared to the secondary display area 508. Moreover, individual instances of content in the primary display area 508 are generally much larger in display size (e.g., a grid cell or a quadrant shown) compared to the instances of content provided in the secondary display area 510 (e.g., circular avatars). This allows a user viewing the graphical user interface to have a higher level of engagement with primary display area participants compared to secondary display area participants at least because the instances of content displayed in the primary display area 508 are often more relevant to the teleconference session 104 than those displayed in the secondary display area 510. In some scenarios, file content can be displayed in the primary display area 508.

In some examples, the secondary display area 510 can be an overlay positioned on top of the primary display area 508. In other examples, a primary display area and a secondary display area can be displayed adjacent to one another (e.g., side-by-side, one on top and one on bottom, etc.). In further examples, only a primary display area is displayed and a secondary display area is not displayed during the teleconference session. For example, if the number of participants in the teleconference session is less than or equal to a maximum threshold number of grid cells predetermined for the primary display area, then the secondary display area is not needed to display additional instances of content that do not fit within the primary display area. In another example, a user control setting may enable a content “view” that minimizes the secondary display area so the user can focus his or her attention on the instances of content displayed in the individual cells of the primary display area.

In additional examples, the user interface can include a display area 512 of the graphical user interface that displays an instance of content being captured at the viewer's own client computing device (e.g., a camera that captures a live video feed of herself or himself) so the viewer can see how she or he appears to others receiving teleconference data. Accordingly, this display area 512 is referred to as “Me”.

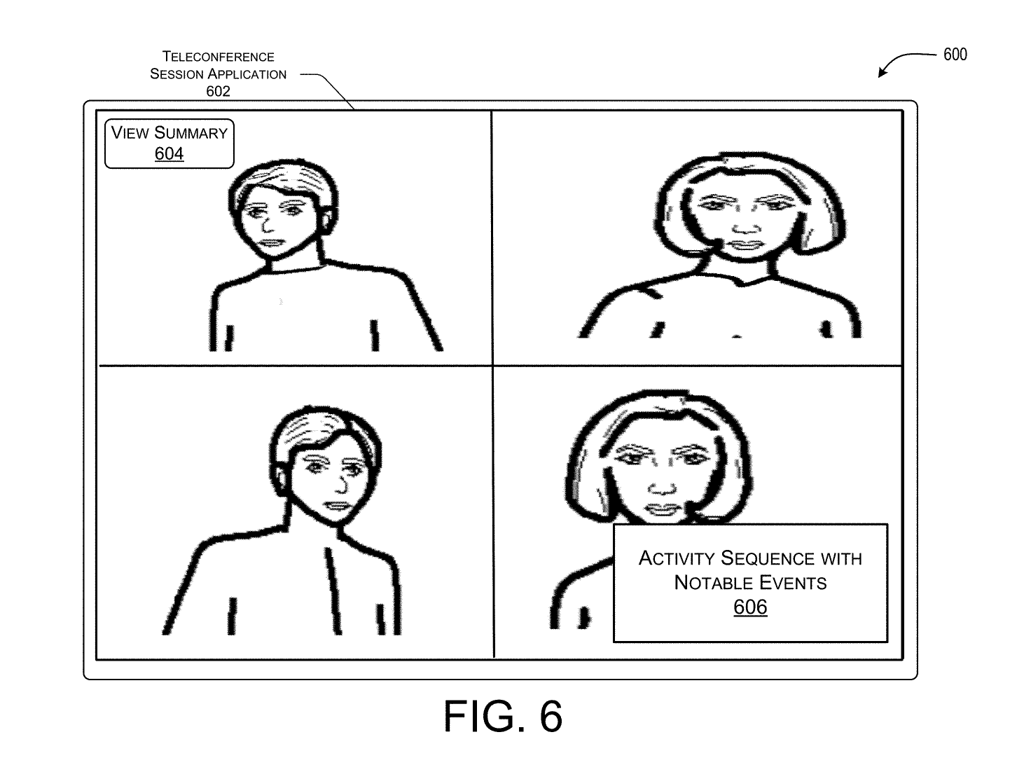

FIG. 6 illustrates another example graphical user interface 600 configured to enable a user to request to view an activity sequence after joining a teleconference session experience provided by a teleconference application and/or to present the activity sequence. Again, the request can be associated with the request for the activity sequence 150 in FIG. 1.

As illustrated in FIG. 6, the request to view the activity sequence is provided via an option to view a summary 604. In response, an activity sequence with notable events 606 is displayed within the teleconference session experience. Here, similar to FIG. 5, the user has already joined the teleconference session (e.g., via one of the meeting objects presented in FIG. 3 or FIG. 4), and thus, live content of the teleconference session that is on-going is being displayed. However, the live content is currently being played back and is not paused, and thus, a user can simultaneously view the live content and the recorded content in the activity sequence with notable events 606.

In various examples, user controls can be enabled to (i) view the live content simultaneously or to pause the live content and only view the activity sequence, (ii) mute audio so that the user can only hear the live content or the recorded content in a simultaneous viewing scenario, and/or (iii) position the activity sequence with notable events 606 so that interference with the live content is minimized in a simultaneous viewing scenario (e.g., the activity sequence with notable events 606 can be associated with a floating control capable of being moved from one location in the user interface to another location).

In further examples, the activity sequence can be interactive such that upon viewing a recorded portion of the teleconference session (e.g., that the user has a strong interest in), a user can provide input that exits the activity sequence and takes the user to a corresponding portion of the full recording so that the user can see more detail surrounding the notable event.

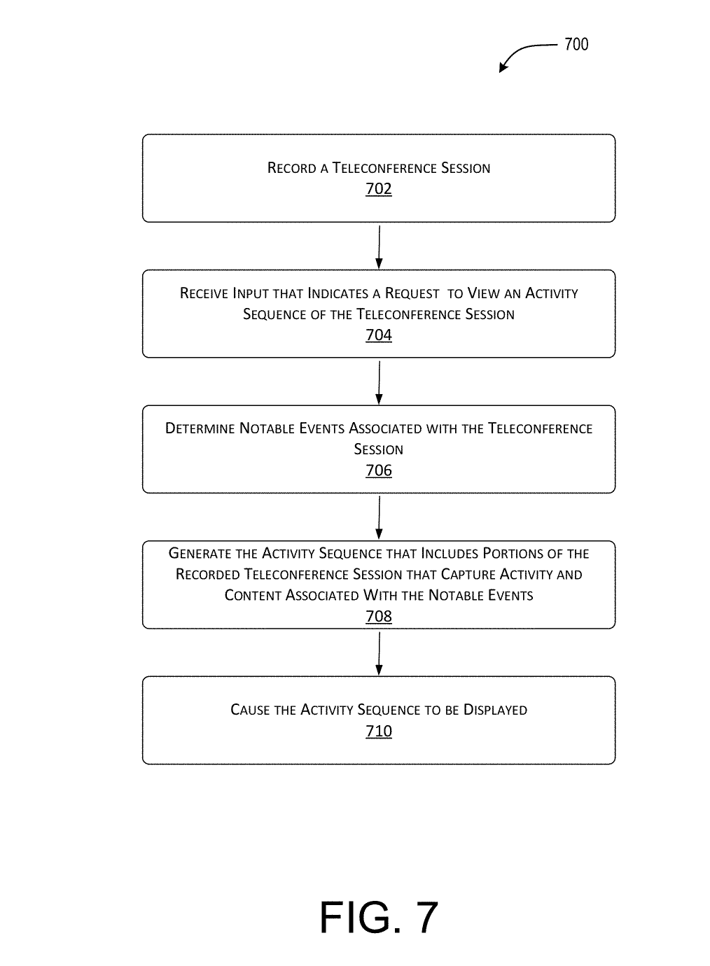

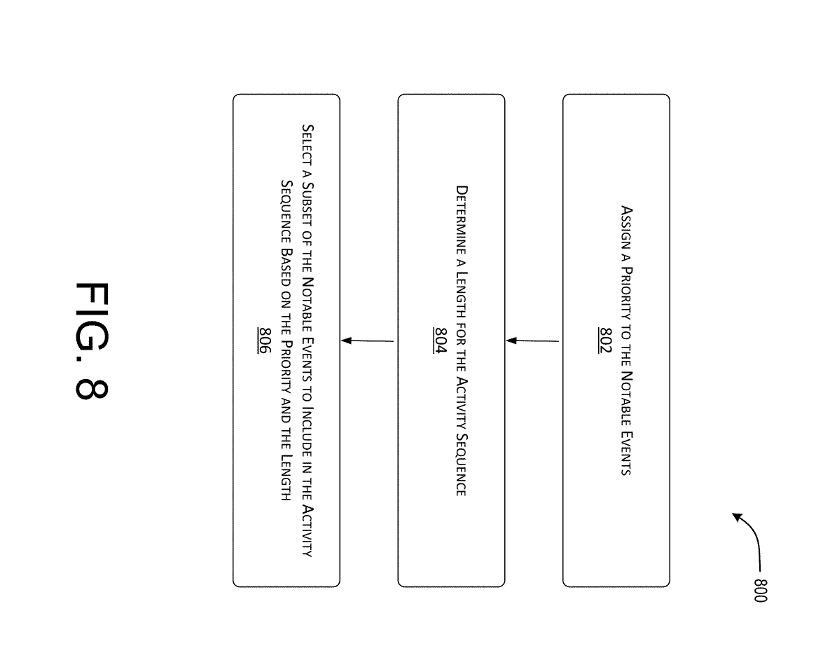

FIGS. 7 and 8 illustrate example flowcharts. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It also should be understood that the illustrated methods can end at any time and need not be performed in its entirety. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system (e.g., device 110, client computing device 106(1), client computing device 106(N), and/or device 200) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

FIG. 7 is a diagram of an example flowchart 700 that illustrates operations directed to generating and outputting (e.g., displaying) an activity sequence on a client computing device.

At operation 702, a teleconference session is recorded. For example, the output module 132 in FIG. 1 can record the teleconference session as it is being conducted, thereby creating a recording of the teleconference session 144 (e.g., a main or a selected instance of teleconference data).

At operation 704, input that indicates requested request to view an activity sequence that summarizes the teleconference session is received. For example, the input can be received by the summary generation module 146 from a client computing device such as client computing device 106(N) (e.g., via the request for the activity sequence 150). Moreover, the request can be provided while the user is interacting with an external application, as described above with respect to the examples of FIG. 3 and FIG. 4, or alternatively, the request can be provided while the user is interacting with a teleconference application, as described above with respect to the examples of FIG. 5 and FIG. 6.

At operation 706, notable events associated with the teleconference session are determined. For example, the summary generation module 146 can be configured to scan a recording of the teleconference session 144 and/or the session data 136 (or session data 210) of the teleconference session, to detect the notable events 148. In some instances, the summary generation module 146 may be configured to continually monitor for notable activity of the various types described herein such as: an action in which a user joins the teleconference session, an action in which a user leaves the teleconference session, an action in which a file and/or a display screen is shared in the teleconference session, an action in which a session topic is introduced in the teleconference session, an action in which a different participant begins speaking in the teleconference session, an action in which file content being displayed in the teleconference session changes, an action in the teleconference session where a user explicitly flags content as being notable, an action in the teleconference session in which a user performs a particular motion or has an increased amount of motion compared to a threshold or normal amount, at least one responsive action by at least one participant in the teleconference session that was likely evoked by at least one previous action by at least one other participant, concentrated activity for a group of participants, etc. Additionally or alternatively, a notable event can be associated with data generated by the system (e.g., a feature where a user adds an emoji to communicate a feeling or a mood, a feature where a user submits an important or relevant comment in a chat, etc.).

At operation 708, the activity sequence is generated. As described above, the activity sequence includes portions of the recorded teleconference session that capture activity and content associated with the notable events. A recorded portion of the teleconference session included in an activity sequence can comprise one or more of a video segment (e.g., a video clip), an audio segment (e.g., an audio clip), still media (e.g., a user avatar, an image, a portion of a file such as a page of a document or a slide in a presentation, etc.), or other content that is visually (e.g., graphically) and/or audibly output in the teleconference session. The recorded portions of the teleconference session can be stacked, or sequenced, together to provide an audio/visual montage (e.g., a preview of important parts of the teleconference session). The duration of an individual recorded portion of the teleconference session is sufficient to capture and illustrate the notable event (e.g., notable activity) contained therein. However, since the activity sequence is generated and presented to save time for a user, a duration of an individual recorded portion of the teleconference session can be short in many instances and may have a maximum duration. For example, a duration of an individual recorded portion may be between one second and thirty seconds where thirty seconds is the maximum duration. In various examples, the duration of a recorded portion of the teleconference session can depend on a type of notable event contained therein (e.g., a user joining, a user leaving, a document being shared, concentrated activity, etc.). In alternative examples, each of the recorded portions of the teleconference session can have the same duration.

In various examples, there is no limit on a length of the activity sequence and the activity sequence contains all the notable events determined by the summary generation module 146. However, in other examples as further described herein, the activity sequence may be limited by a length (e.g., one minute, two minutes, three minutes, five minutes, etc.).

At operation 710, the activity sequence is caused (e.g., via transmission of data) to be displayed via a client computing device. For example, in response to receiving the request for the activity sequence 150, the summary generation module 146 can transmit activity sequence data 152 to a client computing device 106(N) so that it can be displayed and viewed by the user.

As described above, the summary generation module 146 can generate, or at least initiate generation of, the activity sequence before or after the request for the activity sequence is received.

FIG. 8 is a diagram of an example flowchart 800 that illustrates operations directed to selecting a subset of notable events to include in an activity sequence based on priority.

At operation 802, a priority is assigned to the notable events. That is, the activity sequence generation module 146 is configured to use one or more priority factors to calculate and assign a priority value to an individual notable event. A first priority factor can include a type of event. A second priority factor can include a location on a user interface at which activity and content associated with an event occurs. A third priority factor can include a period of time in which file content is displayed. A fourth priority factor can include a number of types of events that are associated with the same activity. A fifth priority factor can include an importance of a person that performs or is a source of a notable event. A sixth priority factor can include temporal proximity of activity. For example, the summary generation module 146 can determine that an amount of activity that occurs within a period of time (e.g., twenty seconds, thirty seconds, a minute, etc.) exceeds a threshold amount of activity defined for the period of time (e.g., the threshold being associated with a normal and/or an expected amount). A seventh priority factor can include an intent to achieve a balance in types of notable events to include in the activity sequence so that the activity sequence is more encompassing and can better capture the context of missed content. Accordingly, a maximum number can be applied to a particular type of notable event to help, or work to, achieve the balance.

Measured activity that can contribute to a determination of whether activity is concentrated, or whether activity that occurs within a period of time exceeds the threshold amount of activity defined for the period of time, can comprise: a number of participants that speak, participant motion or the extent to which a participant moves, participant facial expressions or the extent to which changes in facial expressions occur, an amount of file content modification (e.g., editing a page of a document), and so forth.

In various examples, the summary generation module 146 provides a highest priority to notable events that contain concentrated activity because the concentrated activity includes collaboration between a group of participants that is often significant to understanding the context of a teleconference session.

In some implementations, a host user of the teleconference session (e.g., a person that created and/or shared an object to invite others to a meeting) can specify which priority factors can be used to determine and assign priority to detected events. The host user may specify the priority factors prior to a start of the teleconference session or during the teleconference session.

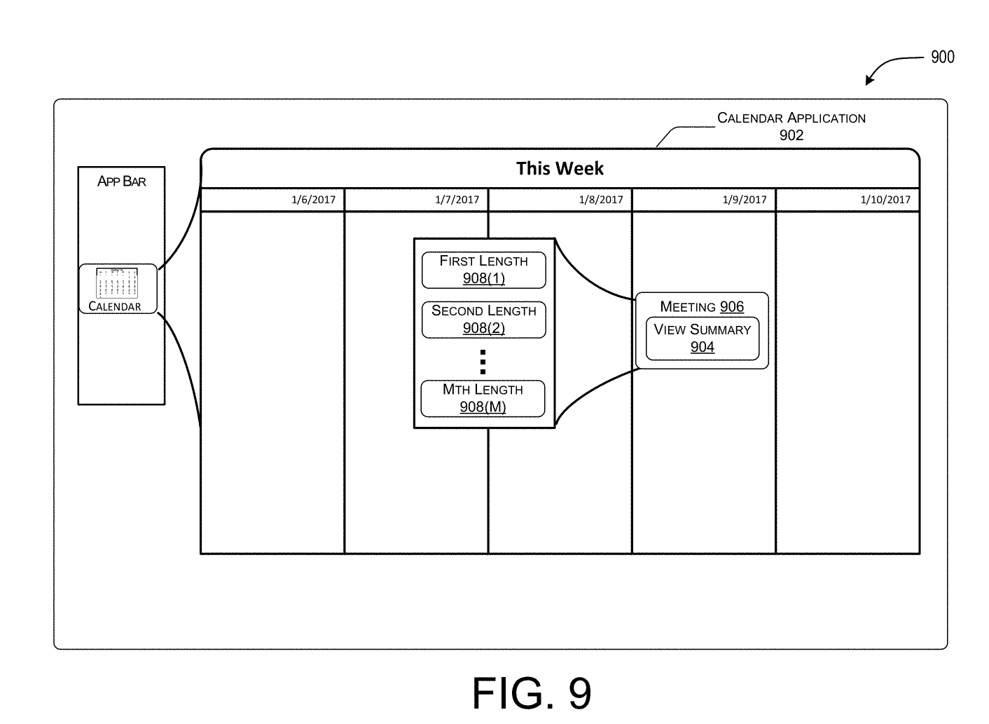

At operation 804, a length of the activity sequence is determined. The length of the activity sequence may be limited and may be defined by the summary generation module 146, or by a user as further described herein with respect to FIG. 9. Moreover, the length limit on the activity sequence may depend on an overall length of the teleconference session to be summarized (e.g., the missed content).

At operation 806, a subset of the notable events to include in the activity sequence is selected based on the priority and the length of the activity sequence. For instance, the summary generation module 146 can be configured to apply a cutoff to a ranked list of notable events so that the higher ranked notable events are included in the activity sequence and fit within a specified length of time (e.g., one minute, two minutes, three minutes, etc.). As described above, the cutoff can be a sliding cutoff that moves up and down the ranked list based on a specified length of the activity sequence and/or individual durations of the recorded portions of the teleconference session to be included in the activity sequence.

FIG. 9 illustrates an example graphical user interface 900 that includes options for a user to select a length of an activity sequence from multiple different available lengths. In this example, the user is interacting with a calendar application 902, and upon selecting an option to view a summary 904 from a meeting object 906 associated with a teleconference session, the user is presented with options to select a length of the activity sequence from available lengths 908(1) through 908(M) (where M is a number greater than one). In this way, a user can have an element of control over a level of detail in the activity sequence (e.g., based on how much available time the user has to consume the activity sequence). For instance, a activity sequence with a length of one minute will likely comprise less recorded portions than a activity sequence with a length of three minutes.

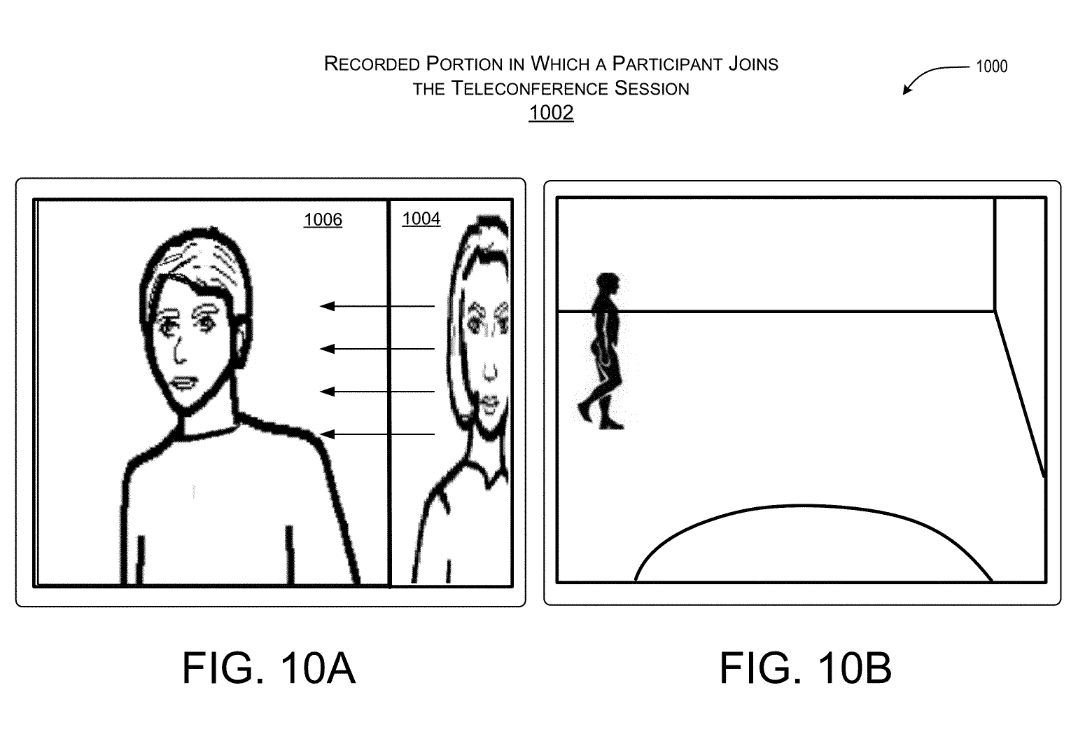

FIGS. 10A and 10B illustrate example graphical user interfaces 1000 that include content and activity associated with a joining event, which can be captured in a recorded portion of the teleconference session. In other words, the graphical user interfaces 1000 can be included in a recorded portion of the teleconference session in which a participant joins the teleconference session 1002. As shown in the example of FIG. 10A, the participant on the right is joining the teleconference session, and thus, the recorded portion includes visual and/or audio content that captures a new instance of content 1004 (e.g., stream) associated with the joining participant being visually introduced within the user interface of the teleconference session. The new instance of content 1004 slides in from the right and pushes an already displayed instance of content 1006 to the left, where the already displayed instance of content 1006 comprises a live feed of the person on the left of the graphical user interface 1000. In the example of FIG. 10B, a person that is walking in the room to sit at a conference table can be detected (e.g., detection can occur when a user walks through an entry way such as a door, when a user enters a scene captured by a camera, etc.). The summary generation module 146 can access session data 210 and/or the recording of the teleconference session 144 to determine (e.g., detect) when a participant joins the teleconference session.

In various examples, the summary generation module 146 can include generate a group representation of who has joined the teleconference session by displaying photos or avatars of those who have joined all at once (e.g., in a single snapshot). This can be done at the start of the activity sequence to inform the user of the participants.

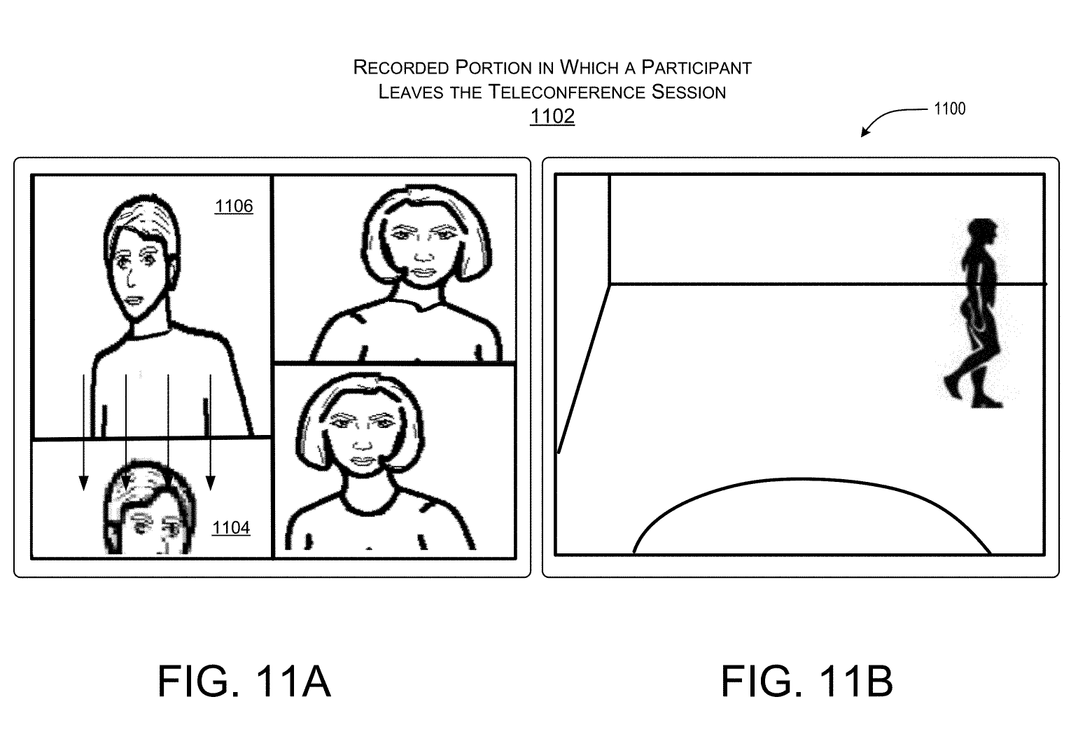

FIGS. 11A and 11B illustrate example graphical user interfaces 1100 that include content and activity associated with a leaving event, which can be captured in a recorded portion of the teleconference session. In other words, the graphical user interfaces 1100 can be included in a recorded portion of the teleconference session in which a participant leaves the teleconference session 1102. As shown in the example of FIG. 11A, the participant in the bottom left quadrant is leaving the teleconference session, and thus, the recorded portion 1102 includes visual and/or audio content that captures an instance of content 1104 (e.g., stream) associated with the leaving participant being visually removed from the user interface of the teleconference session. In this example, an already displayed instance of content 1106 slides down, expands, and pushes the instance of content 1104 off the user interface. In the example of FIG. 11B, a person that is walking out of the room to leave the meeting can be detected (e.g., detection can occur when a user walks out of an entry way such as a door, when a user leaves a scene captured by a camera, etc.). The summary generation module 146 can access session data 210 and/or the recording of the teleconference session 144 to determine (e.g., detect) when a participant leaves the teleconference session.

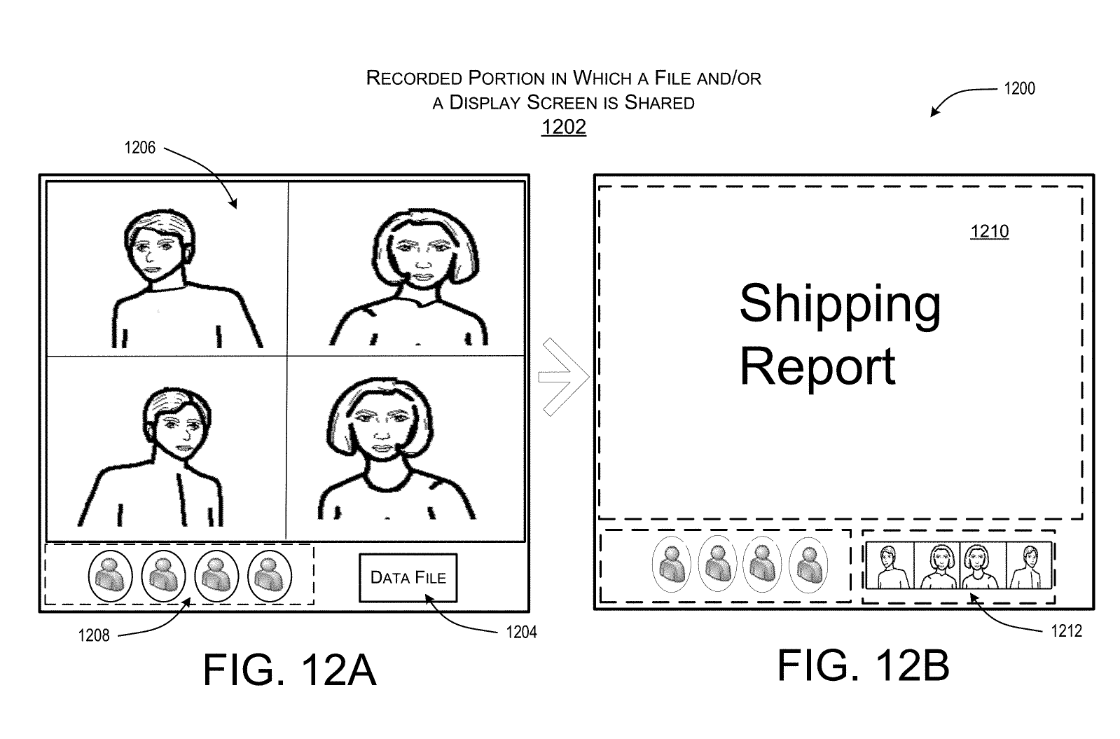

FIGS. 12A and 12B illustrate example graphical user interfaces 1200 that include content and activity associated with a file and/or display screen sharing event, which can be captured in a recorded portion of the teleconference session. In other words, the graphical user interfaces 1200 show a transition that can be included in a recorded portion of the teleconference session, the transition capturing the sharing of a file and/or a display screen 1202. As shown in this example, the graphical user interface of FIG. 12A illustrates a data file 1204 that is displayed at the bottom of the graphical user interface. The data file 1204 is associated with the file and/or display screen to be shared. The graphical user interface of FIG. 12A further illustrates a primary display area 1206 that contains streams of live content for four active participants and a secondary display area 1208 that contains instances of content (e.g., avatars) representing four passive participants. Based on user control during the teleconference session, the data file 1204 can be initially shared and/or moved to the primary display area, as shown by 1210 in the graphical user interface of FIG. 12B. Moreover, the four active participants that previously were displayed in the primary display area 1206 can be moved to a display area 1212 at the bottom of the screen, as shown in the graphical user interface of FIG. 12B. Consequently, the graphical user interfaces of FIGS. 12A and 12B capture when a file and/or a display screen is shared to an audience, thereby contributing to an understanding of the context of the teleconference session. The summary generation module 146 can access session data 210 and/or the recording of the teleconference session 144 to determine (e.g., detect) when a data file and/or a display screen is initially shared in the teleconference session.

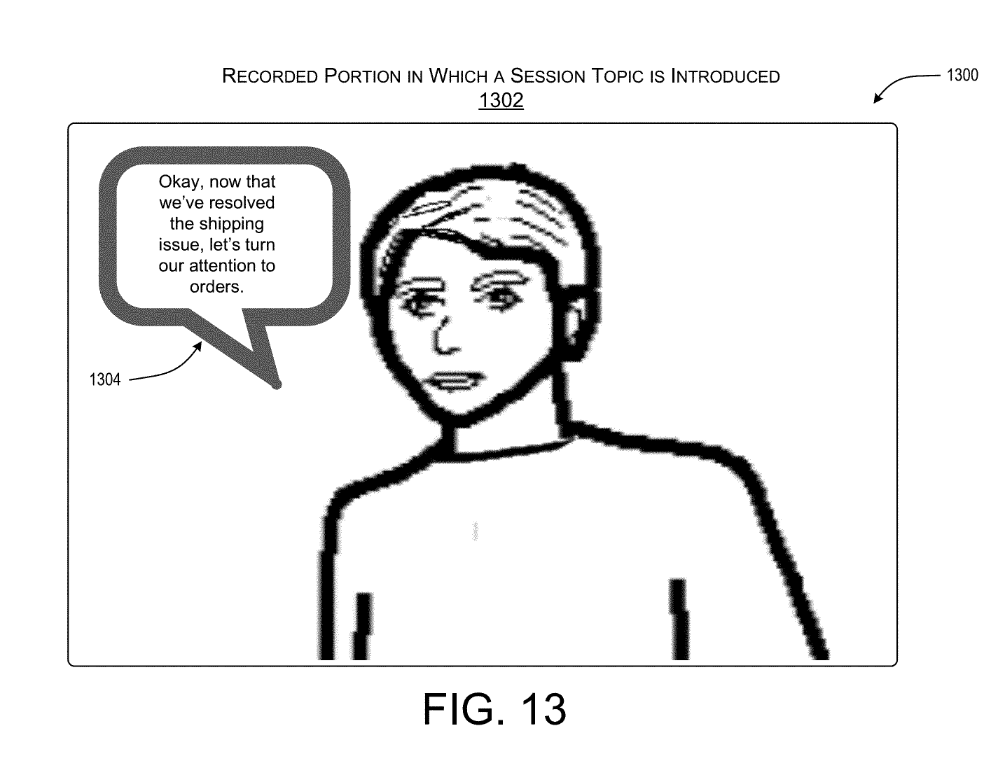

FIG. 13 illustrates an example graphical user interface 1300 that includes content and activity associated with a topic introduction event, which can be captured in a recorded portion of the teleconference session. In other words, the graphical user interface 1300 can be included in a recorded portion of the teleconference session in which a session topic is introduced 1302. As shown in this example, a participant states: “Okay, now that we've resolved shipping, let's turn our attention to orders” 1304. The words spoken by the participant are likely associated with a switch in topics, or a switch from a topic of shipping to a topic of orders. The summary generation module 146 can access session data 210 and/or the recording of the teleconference session 144 to determine (e.g., detect) when the discussion switched from one topic to the next. For example, the summary generation module 146 can access a transcription of what was spoken during the teleconference session to determine keywords or phrases associated with a topic (e.g., words commonly spoken in association with a topic) and/or trigger words or phrases that indicate a switch in topics (e.g., “turn our attention to”, “moving on”, “now that the first problem is resolved let's discuss the next”, etc.). Based on the evaluation of the keywords and trigger words, the summary generation module 146 can determine when a new topic is introduced in the teleconference session.

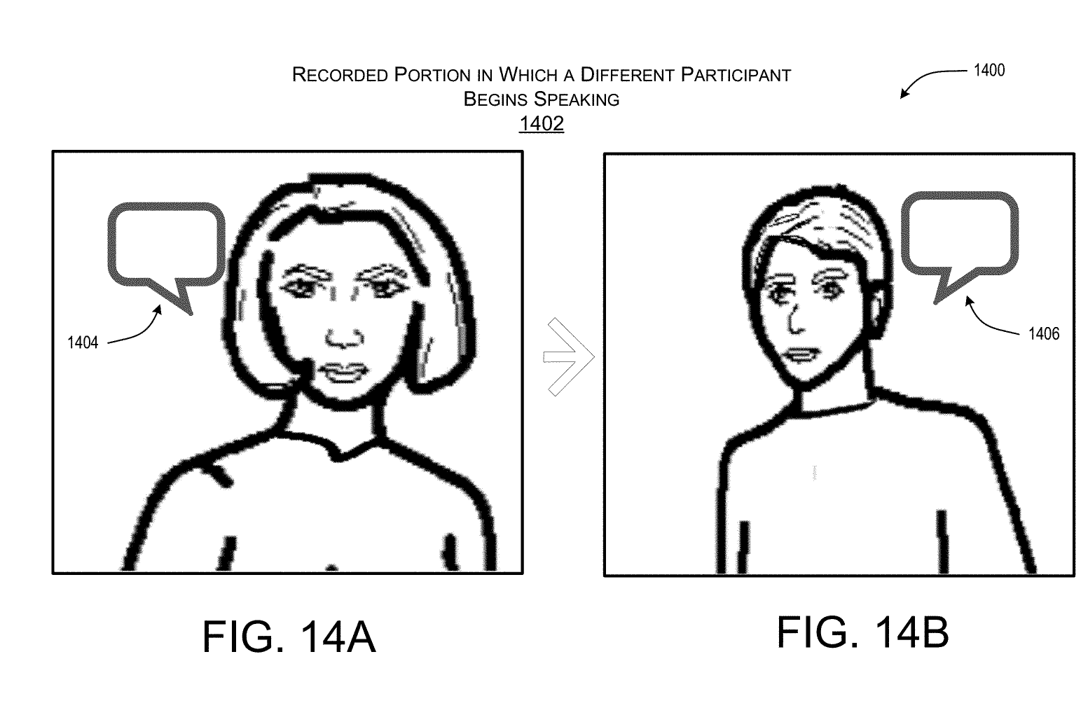

FIGS. 14A and 14B illustrate example graphical user interfaces 1400 that include content and activity associated with a change in speaker event, which can be captured in a recorded portion of the teleconference session. In other words, the graphical user interfaces 1400 show a transition that can be included in a recorded portion of the teleconference session, the transition capturing when a different participant begins speaking 1402 (e.g., there is a new speaker). As shown in this example, the graphical user interface of FIG. 14A includes a first participant speaking 1404 and the graphical user interface of FIG. 14B includes a second participant speaking 1406. The teleconference session switched the display from the first participant to the second participant when the first participant stopped speaking and the second participant begins speaking. In other examples, both the first participant and the second participant can be displayed simultaneously. Consequently, the graphical user interfaces of FIGS. 14A and 14B capture when a different participant begins speaking, thereby contributing to an understanding of the context of the teleconference session. The summary generation module 146 can access session data 210 and/or the recording of the teleconference session 144 to determine (e.g., detect) when a different participant begins speaking in the teleconference session.

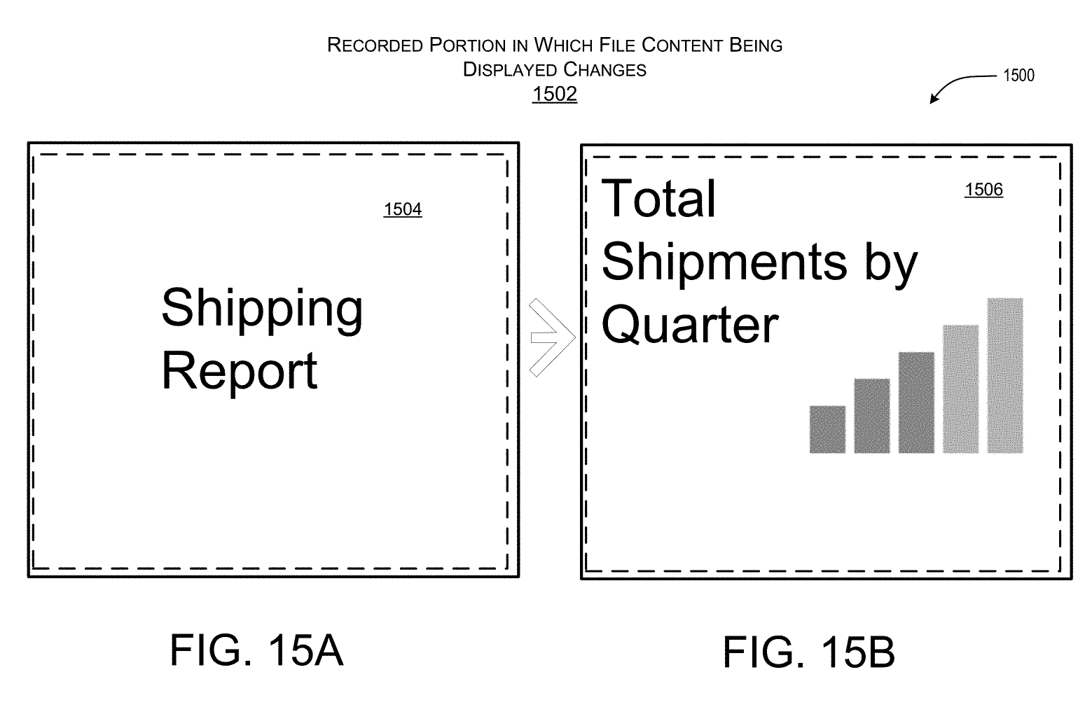

FIGS. 15A and 15B illustrate example graphical user interfaces 1500 that include content and activity associated with a change in displayed file content event, which can be captured in a recorded portion of the teleconference session. In other words, the graphical user interfaces 1500 show a transition that can be included in a recorded portion of the teleconference session, the transition capturing a change in file content that is displayed 1502 (e.g., in the primary display area). As shown in this example, the graphical user interface of FIG. 15A illustrates a currently displayed page or slide of a file (e.g., the data file from FIGS. 12A and 12B) entitled “Shipping Report” 1504, while the graphical user interface of FIG. 15B illustrates a next displayed page or slide of a file entitled “Total Shipments by Quarter” 1506. Consequently, the graphical user interfaces of FIGS. 15A and 15B capture when displayed filed content changes, thereby contributing to an understanding of the context of the teleconference session. The summary generation module 146 can access session data 210 and/or the recording of the teleconference session 144 to determine (e.g., detect) when displayed filed content changes in the teleconference session. In various examples, the summary generation module 146 prioritizes pages or slides of a file that are displayed in the primary display area longer than other pages or slides.

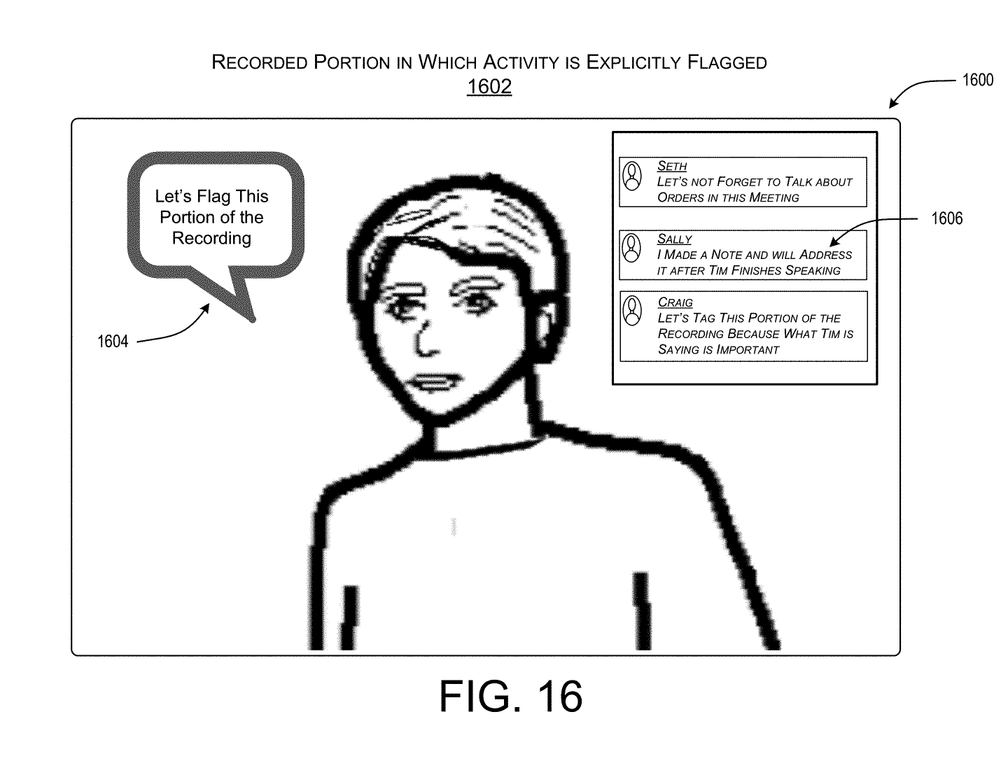

FIG. 16 illustrates an example graphical user interface 1600 that includes content and activity associated with an explicitly flagged event, which can be captured in a recorded portion of the teleconference session. In other words, the graphical user interface 1600 can be included in a recorded portion of the teleconference session in which activity is explicitly flagged 1602. As shown in this example, a participant explicitly states: “Let's flag this portion of the recording” 1604. As further shown in this example, and as an alternative, a chat comment 1606 provided by a participant (e.g., Sally) to the teleconference session can indicate “Let's flag this portion of the recording because what Tim is saying is important”. The summary generation module 146 can access session data 210 and/or the recording of the teleconference session 144 to determine at which point in the teleconference session activity is explicitly flagged. That is, the summary generation module 146 can locate keywords such as “flag”, “tag”, “mark”, etc. in text from comments and/or a transcription to detect flagged activity. Subsequently, the summary generation module 146 can apply a window of time (e.g., five seconds before and/or after the explicit flag, ten seconds before and/or after the explicit flag, etc.) to capture explicitly flagged activity and content to include in a recorded portion of the teleconference session.

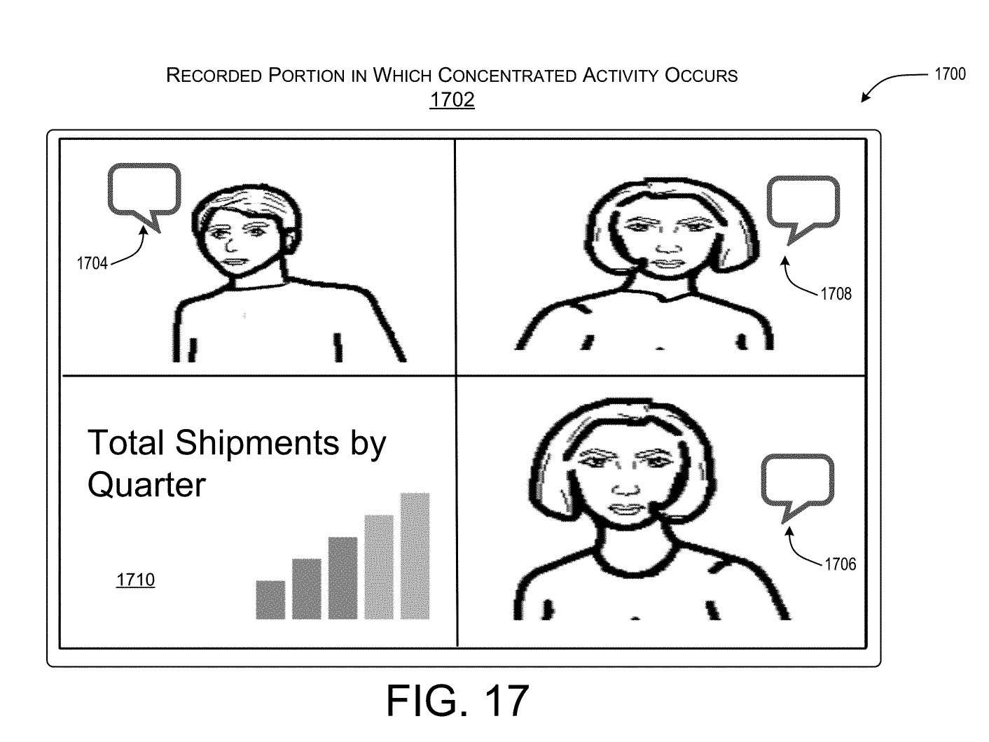

FIG. 17 illustrates an example graphical user interface 1700 that includes content and activity associated with a concentrated activity event, which can be captured in a recorded portion of the teleconference session. In other words, the graphical user interface 1700 can be included in a recorded portion of the teleconference session in which concentrated activity occurs 1702. As shown in this example, a first participant is speaking 1704 within a period of time (e.g., five seconds, ten seconds, etc.), a second participant is speaking 1706 within the period of time, and a third participant is speaking 1708 within the period of time. In various examples, the participants may be speaking about and/or editing file content 1710. This amount of activity can exceed a threshold amount of activity established for the period of time (e.g., the threshold being only one speaking participant or two speaking participants, etc.). The summary generation module 146 can access session data 210 and/or the recording of the teleconference session 144 to detect the concentrated activity in the teleconference session.

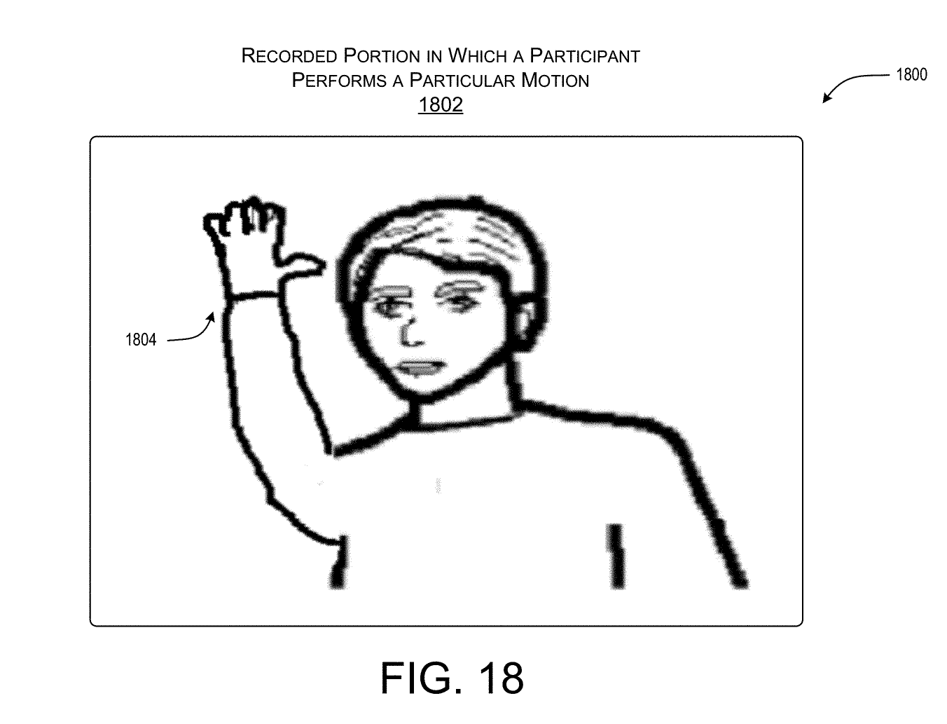

FIG. 18 illustrates an example graphical user interface 1800 that includes content and activity associated with a motion event, which can be captured in a recorded portion of the teleconference session. In other words, the graphical user interface 1800 can be included in a recorded portion of the teleconference session in which a participant performs a particular motion 1802. As shown in this example, the particular motion comprises a participant raising a hand 1804. The summary generation module 146 can access session data 210 and/or the recording of the teleconference session 144 to graphically determine (e.g., detect) when a participant performs a particular motion which is being monitored for. In some examples, notable motion may not be a particular motion (e.g., the raising of a hand), but any motion—an amount of which exceeds a threshold amount of motion (e.g., a baseline amount of motion that is normal for participants sitting and interacting with each other via a teleconference session).

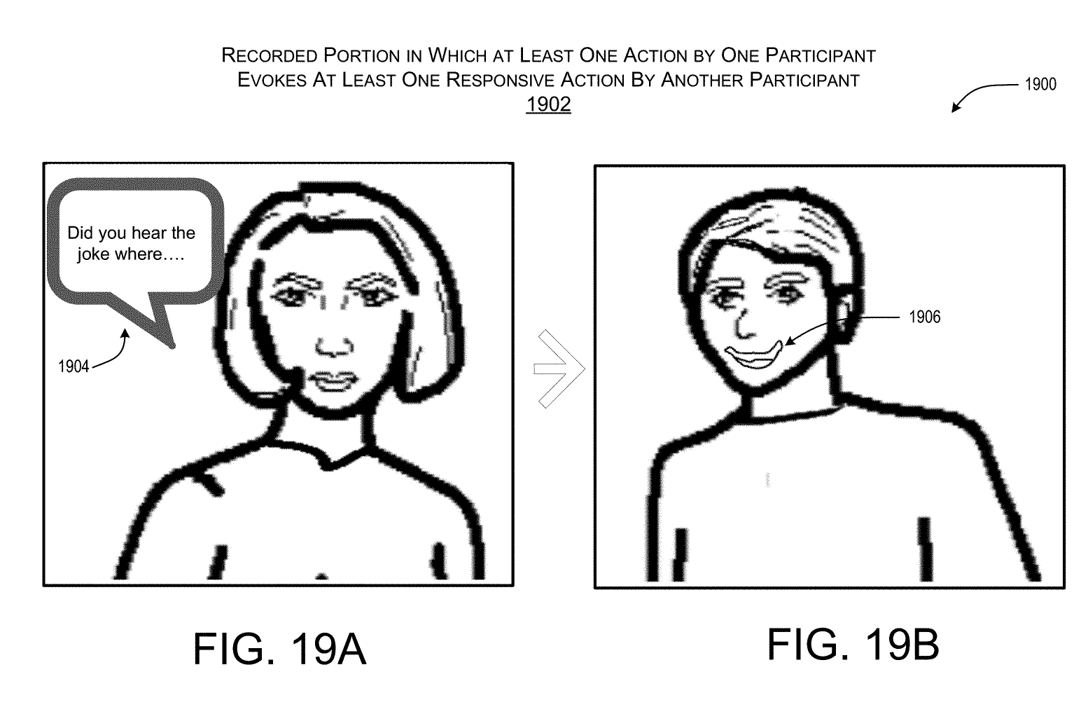

FIGS. 19A and 19B illustrate example graphical user interfaces 1900 that include content and activity associated with an evoked response event, which can be captured in a recorded portion of the teleconference session. In other words, the graphical user interfaces 1900 show at least one action that evokes at least one responsive action 1902. As shown in this example, the graphical user interface of FIG. 19A includes a first participant telling a joke 1904 and the graphical user interface of FIG. 19B includes a second participant smiling 1906 in response to listening to the joke. In one example, the teleconference session switches the display from the first participant to the second participant when the second participant smiles. In other examples, both the first participant and the second participant can be displayed simultaneously. Consequently, the graphical user interfaces of FIGS. 19A and 19B capture when one action by one participant evokes a responsive action by another participant, thereby contributing to an understanding of the context of the teleconference session. The summary generation module 146 can access session data 210 and/or the recording of the teleconference session 144 to determine (e.g., detect) when an action evokes a responsive action in the teleconference session.

The disclosure presented herein may be considered in view of the following example clauses.

Example Clause A, a system comprising: one or more processing units; and a computer-readable medium having encoded thereon computer-executable instructions to cause the one or more processing units to: record a teleconference session; receive input that indicates a request to view an activity sequence that summarizes the teleconference session; determine a plurality of notable events that occur within the teleconference session; generate the activity sequence based at least in part on a subset of the plurality of notable events, wherein the activity sequence includes recorded portions of the teleconference session that individually capture activity and content associated with a notable event; and cause the activity sequence to be displayed via a client computing device.

Example Clause B, the system of Example Clause A, wherein the computer-executable instructions further causing the one or more processing units to: assign a priority to the plurality of notable events; and select the subset of the plurality of notable events based at least in part on the priority assigned to the plurality of notable events, and wherein: an individual notable event comprises an action in which a participant joins the teleconference session and the activity sequence comprises a recorded portion of the teleconference session that includes visual and/or audio content within which the participant joins the teleconference session.

Example Clause C, the system of Example Clause B, wherein the priority is based at least in part on one or more priority factors comprising: a type of notable event, a location at which a notable event occurs within a user interface that displays the teleconference session, or temporal proximity of activity.

Example Clause D, the system of Example Clause A or Example Clause B, wherein the input comprises a length of the activity sequence which is selected from multiple available lengths, the computer-executable instructions further causing the one or more processing units to select the subset of the plurality of notable events further based at least in part on the length of the activity sequence selected.

Example Clause E, the system of any one of Example Clause A through Example Clause D, wherein the teleconference session is on-going, the computer-executable instructions further causing the one or more processing units to cause the activity sequence to be displayed prior to causing live content of the on-going teleconference session to be displayed.

Example Clause F, the system of any one of Example Clause A through Example Clause E, wherein an individual notable event comprises an action in which a participant leaves the teleconference session and the activity sequence comprises a recorded portion of the teleconference session that includes visual and/or audio content within which the participant leaves the teleconference session.

Example Clause G, the system of any one of Example Clause A through Example Clause F, wherein an individual notable event comprises an action in which a file and/or a display screen is shared in the teleconference session and the activity sequence comprises a recorded portion of the teleconference session that includes visual and/or audio content within which the file and/or the display screen is shared.

Example Clause H, the system of any one of Example Clause A through Example Clause G, wherein an individual notable event comprises an action in which a session topic is introduced in the teleconference session and the activity sequence comprises a recorded portion of the teleconference session that includes visual and/or audio content within which the session topic is introduced.

Example Clause I, the system of any one of Example Clause A through Example Clause H, wherein an individual notable event comprises an action in which a different participant begins speaking and the activity sequence comprises a recorded portion of the teleconference session that includes visual and/or audio content within which the different participant begins speaking.

Example Clause J, the system of any one of Example Clause A through Example Clause I, wherein an individual notable event comprises an action in which file content being displayed in the teleconference session is changed and the activity sequence comprises a recorded portion of the teleconference session within which the file content being displayed is changed.

Example Clause K, the system of any one of Example Clause A through Example Clause J, wherein an individual notable event comprises an action in the teleconference session that explicitly flags content as being notable and the activity sequence comprises a recorded portion of the teleconference session that includes the explicitly flagged content.

Example Clause L, the system of any one of Example Clause A through Example Clause K, wherein an individual notable event comprises concentrated activity in which an amount of group activity over a period of time exceeds a threshold amount of activity and the activity sequence comprises a recorded portion of the teleconference session that includes visual and/or audio content within which the concentrated activity occurs.

Example Clause M, the system of any one of Example Clause A through Example Clause L, wherein an individual notable event comprises an action in which a participant performs a particular motion in the teleconference session and the activity sequence comprises a recorded portion of the teleconference session that includes visual and/or audio content within which the participant performs the particular motion.

Example Clause N, the system of any one of Example Clause A through Example Clause M, wherein an individual notable event comprises at least one responsive action by at least one participant in the teleconference session that was likely evoked by at least one previous action by at least other participant and the activity sequence comprises a recorded portion of the teleconference session that includes visual and/or audio content within which the at least one previous action evokes the at least one responsive action.

While the subject matter of Example Clauses A through N is described above with respect to a system, it is also understood in the context of this disclosure that the subject matter of Example Clauses A through N can be implemented by a device, as a method, and/or via executable instructions stored in computer-readable storage media.

Example Clause O, a method comprising: recording a teleconference session; determining, by one or more processing units, notable events associated with the teleconference session as the teleconference session is being recorded; generating an activity sequence for the teleconference session that includes recorded portions of the teleconference session that individually capture activity and content associated with a notable event; receiving input that indicates a request to view the activity sequence; and causing the activity sequence to be displayed via a client computing device.

Example Clause P, the method of Example Clause O, wherein the teleconference session is on-going, the method further comprising causing the activity sequence to be displayed prior to causing live content of the on-going teleconference session to be displayed.

Example Clause Q, the method of Example Clause O, wherein the teleconference session is on-going, the method further comprising causing the activity sequence to be displayed simultaneously with live content of the on-going teleconference session.

Example Clause R, the method of any one of Example Clause O through Example Clause Q, further comprising causing the activity sequence to be displayed within a user interface associated with a teleconference application.

Example Clause S, the method of Example Clause O or Example Clause P, further comprising causing the activity sequence to be displayed in association with an object of an application that is separate from a teleconference application.

While the subject matter of Example Clauses O through S is described above with respect to a method, it is also understood in the context of this disclosure that the subject matter of Example Clauses O through S can be implemented by a device, by a system, and/or via executable instructions stored in computer-readable storage media.

Example Clause T, a computer-readable storage medium having encoded thereon computer-executable instructions that, when executed by one or more processing units, cause the one or more processing units to: record a teleconference session; receive input that indicates a request to view an activity sequence of the teleconference session; determine a plurality of notable events that occur within the teleconference session; prioritizing one or more of the plurality of notable events that are associated with concentrated activity, wherein the concentrated activity comprises an amount of activity in a period of time that exceeds a threshold amount of activity defined for the period of time; select, based at least in part on the prioritizing, at least the one or more of the plurality of notable events to include in the activity sequence; generate the activity sequence including the one or more of the plurality of notable events, wherein the activity sequence includes recorded portions of the teleconference session that individually capture activity and content associated with a notable event; and cause the activity sequence to be displayed via a client computing device.

While the subject matter of Example Clause T is described above with respect to a computer-readable storage medium, it is also understood in the context of this disclosure that the subject matter of Example Clause T can be implemented by a device, by a system, and/or as a method.

Although the techniques have been described in language specific to structural features and/or methodological acts, it is to be understood that the appended claims are not necessarily limited to the features or acts described. Rather, the features and acts are described as example implementations of such techniques.

The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A system comprising:
one or more processing units; and
a computer-readable medium having encoded thereon computer-executable instructions to cause the one or more processing units to:
record a teleconference session;
receive input that indicates a request to view an activity sequence that summarizes the teleconference session;
determine a plurality of notable events that occur within the teleconference session;
generate the activity sequence based at least in part on a subset of the plurality of notable events, wherein the activity sequence includes recorded portions of the teleconference session that individually capture activity and content associated with a notable event; and
cause the activity sequence to be displayed via a client computing device.

2. The system of claim 1, wherein the computer-executable instructions further causing the one or more processing units to:
assign a priority to the plurality of notable events; and
select the subset of the plurality of notable events based at least in part on the priority assigned to the plurality of notable events, and wherein:
an individual notable event comprises an action in which a participant joins the teleconference session and the activity sequence comprises a recorded portion of the teleconference session that includes visual and/or audio content within which the participant joins the teleconference session.

3. The system of claim 2, wherein the priority is based at least in part on one or more priority factors comprising: a type of notable event, a location at which a notable event occurs within a user interface that displays the teleconference session, or temporal proximity of activity.

4. The system of claim 2, wherein the input comprises a length of the activity sequence which is selected from multiple available lengths, the computer-executable instructions further causing the one or more processing units to select the subset of the plurality of notable events further based at least in part on the length of the activity sequence selected.

5. The system of claim 1, wherein the teleconference session is on-going, the computer-executable instructions further causing the one or more processing units to cause the activity sequence to be displayed prior to causing live content of the on-going teleconference session to be displayed.

6. The system of claim 1, wherein an individual notable event comprises an action in which a participant leaves the teleconference session and the activity sequence comprises a recorded portion of the teleconference session that includes visual and/or audio content within which the participant leaves the teleconference session.

7. The system of claim 1, wherein an individual notable event comprises an action in which a file and/or a display screen is shared in the teleconference session and the activity sequence comprises a recorded portion of the teleconference session that includes visual and/or audio content within which the file and/or the display screen is shared.

8. The system of claim 1, wherein an individual notable event comprises an action in which a session topic is introduced in the teleconference session and the activity sequence comprises a recorded portion of the teleconference session that includes visual and/or audio content within which the session topic is introduced.

9. The system of claim 1, wherein an individual notable event comprises an action in which a different participant begins speaking and the activity sequence comprises a recorded portion of the teleconference session that includes visual and/or audio content within which the different participant begins speaking.

10. The system of claim 1, wherein an individual notable event comprises an action in which file content being displayed in the teleconference session is changed and the activity sequence comprises a recorded portion of the teleconference session within which the file content being displayed is changed.

11. The system of claim 1, wherein an individual notable event comprises an action in the teleconference session that explicitly flags content as being notable and the activity sequence comprises a recorded portion of the teleconference session that includes the explicitly flagged content.

12. The system of claim 1, wherein an individual notable event comprises concentrated activity in which an amount of group activity over a period of time exceeds a threshold amount of activity and the activity sequence comprises a recorded portion of the teleconference session that includes visual and/or audio content within which the concentrated activity occurs.

13. The system of claim 1, wherein an individual notable event comprises an action in which a participant performs a particular motion in the teleconference session and the activity sequence comprises a recorded portion of the teleconference session that includes visual and/or audio content within which the participant performs the particular motion.

14. The system of claim 1, wherein an individual notable event comprises at least one responsive action by at least one participant in the teleconference session that was likely evoked by at least one previous action by at least other participant and the activity sequence comprises a recorded portion of the teleconference session that includes visual and/or audio content within which the at least one previous action evokes the at least one responsive action.

15. A method comprising:
recording a teleconference session;
determining, by one or more processing units, notable events associated with the teleconference session as the teleconference session is being recorded;
generating an activity sequence for the teleconference session that includes recorded portions of the teleconference session that individually capture activity and content associated with a notable event;
receiving input that indicates a request to view the activity sequence; and
causing the activity sequence to be displayed via a client computing device.

16. The method of claim 15, wherein the teleconference session is on-going, the method further comprising causing the activity sequence to be displayed prior to causing live content of the on-going teleconference session to be displayed.

17. The method of claim 15, wherein the teleconference session is on-going, the method further comprising causing the activity sequence to be displayed simultaneously with live content of the on-going teleconference session.

18. The method of claim 15, further comprising causing the activity sequence to be displayed within a user interface associated with a teleconference application.

19. The method of claim 15, further comprising causing the activity sequence to be displayed in association with an object of an application that is separate from a teleconference application.

20. A computer-readable storage medium having encoded thereon instructions that, when executed by one or more processing units, cause the one or more processing units to:
record a teleconference session;
receive input that indicates a request to view an activity sequence of the teleconference session;
determine a plurality of notable events that occur within the teleconference session;
prioritizing one or more of the plurality of notable events that are associated with concentrated activity, wherein the concentrated activity comprises an amount of activity in a period of time that exceeds a threshold amount of activity defined for the period of time;
select, based at least in part on the prioritizing, at least the one or more of the plurality of notable events to include in the activity sequence;
generate the activity sequence including the one or more of the plurality of notable events, wherein the activity sequence includes recorded portions of the teleconference session that individually capture activity and content associated with a notable event; and
cause the activity sequence to be displayed via a client computing device.
